(19) United States
(12) Patent Application Publication
(10) Pub. No.: US 2025/0236712 A1
(43) Pub. Date: Jul. 24, 2025

(54) FILLER-CONTAINING FILM

(71) Applicant: DEXERIALS CORPORATION, Shimotsuke-shi (JP)

(72) Inventor: Reiji TSUKAO, Utsunomiya-shi (JP)

(73) Assignee: DEXERIALS CORPORATION, Shimotsuke-shi (JP)

(21) Appl. No.: 19/172,283

(22) Filed: Apr. 7, 2025

Related U.S. Application Data
(62) Division of application No. 16/340,635, filed on Apr. 9, 2019.

(30) Foreign Application Priority Data
Oct. 18, 2016 (JP) 2016-204750
Apr. 23, 2017 (JP) 2017-084915
Aug. 20, 2017 (JP) 2017-158303
Aug. 30, 2017 (JP) 2017-166276

(51) Int. Cl. C08J 5/18; B32B 27/18; H01B 1/22; H01B 5/16; H01R 11/01; H01R 43/00

(52) U.S. Cl. CPC C08J 5/18; B32B 27/18; H01B 1/22; H01B 5/16; H01R 11/01; H01R 43/00

(57) ABSTRACT

In a filler-containing film in which fillers are dispersed in a resin layer, an unnecessary flow movement of the fillers due to an unnecessary flow movement of the resin layer is suppressed at the time when the filler-containing film is bonded to an article by pressure bonding. A filler-containing film includes a filler dispersion layer in which fillers are dispersed in a resin layer. In the filler dispersion layer, the surface of the resin layer in the vicinity of the fillers includes inclinations or undulations with respect to a tangent plane to a central portion of the surface of the resin layer between adjacent fillers. The CV value of the particle diameter of these fillers is not greater than 20%.

### RELATED APPLICATIONS

The present application is a divisional application of U.S. application Ser. No. 16/340,635 filed Apr. 9, 2019, which in turn is a U.S. national stage application of PCT/JP2017/036993 filed Oct. 12, 2017, claiming priority to JP 2016-204750 filed Oct. 18, 2016, JP 2017-084915 filed Apr. 23, 2017, JP 2017-158303 filed Aug. 20, 2017 and JP 2017-16276 filed Aug. 30, 2017. Each of these prior applications is incorporated herein by reference in its entirety.

### TECHNICAL FIELD

The present invention relates to a filler-containing film.

### BACKGROUND ART

A filler-containing film in which fillers are dispersed in a resin layer is used for diverse purposes such as matte films, films for capacitors, optical films, films for labels, antistatic films, and anisotropic conductive films (Patent Document 1, Patent Document 2, Patent Document 3, and Patent Document 4). When the filler-containing film is bonded by thermocompression bonding to an article that is an adherend for the filler-containing film, it is desirable, from the perspectives of optical properties, mechanical properties, and electrical properties, to suppress unnecessary resin flow movement of the resin that forms the filler-containing film and then to suppress uneven distribution of the fillers. In particular, in the case where a filler-containing film in which conductive particles are contained as fillers is used as an anisotropic conductive film used for mounting an electronic component such as an IC chip, the conductive particles are densely dispersed in an insulating resin layer to correspond to high density mounting of the electronic component, and thus, the densely dispersed conductive particles undergo unnecessary movement due to the flow movement of the resin at the time of mounting of the electronic component and distribute unevenly between terminals, which results in the occurrence of short circuits.

On the other hand, an anisotropic conductive film has been proposed in which a photocurable resin layer having conductive particles embedded therein in a single layer and an insulating adhesive layer are layered to reduce the occurrence of short circuits and improve workability at the time of bonding the anisotropic conductive film to a substrate by temporary pressure bonding (Patent Document 5). A usage method of this anisotropic conductive film is as follows. Before curing, temporary pressure bonding is performed in a state where the photocurable resin layer has tackiness, next, the photocurable resin layer is photocured and the conductive particles are fixed, and afterwards, final pressure bonding between the substrate and an electronic component is performed via the anisotropic conductive film.

Furthermore, an anisotropic conductive film having a three layer-structure has also been proposed, in which a first connection layer is held between a second connection layer and a third connection layer which are mainly formed of an insulating resin to achieve a similar objective to Patent Document 5 (Patent Documents 6 and 7). Specifically, in the anisotropic conductive film according to Patent Document 6, the first connection layer has a structure in which the conductive particles are arranged in a single layer in a plane direction of the insulating resin layer on the side of the second connection layer, and a thickness of the insulating resin layer in a central area between adjacent conductive particles is thinner than a thickness of the insulating resin layer in the vicinity of the conductive particles. On the other hand, in the anisotropic conductive film according to Patent Document 7, a boundary between the first connection layer and the third connection layer has a structure including undulations and the first connection layer has a structure in which the conductive particles are arranged in a single layer in a plane direction of the insulating resin layer on the side of the third connection layer, and the thickness of the insulating resin layer in a central area between adjacent conductive particles is thinner than the thickness of the insulating resin layer in the vicinity of the conductive particles.

### CITATION LIST

### Patent Literature

Patent Document 1: JP 2006-15680 A

Patent Document 2: JP 2015-138904 A

Patent Document 3: JP 2013-103368 A

Patent Document 4: JP 2014-183266 A

Patent Document 5: JP 2003-64324 A

Patent Document 6: JP 2014-060150 A

Patent Document 7: JP 2014-060151 A

### SUMMARY OF INVENTION

### Technical Problem

However, in the anisotropic conductive film described in Patent Document 5, there is a problem in that the conductive particles tend to move at the time of temporary pressure bonding of the anisotropic conductive connection and thus, the precise disposition of the conductive particles before the anisotropic conductive connection can not be maintained after the anisotropic conductive connection or a sufficient distance can not be formed between the conductive particles. Furthermore, when the photocurable resin layer was photocured after temporary pressure bonding of such an anisotropic conductive film to a substrate and the photocured resin layer in which the conductive particles are embedded was bonded to an electronic component, there were a problem in that capturing of the conductive particles was difficult at an end part of a bump of the electronic component and a problem in that excessively large force was necessary for pushing the conductive particles and thus, it was not possible to sufficiently push the conductive particles. Furthermore, a discussion on points such as an exposure of the conductive particles from the photocurable resin layer to improve the pushing of the conductive particles has not been sufficiently performed in Patent Document 5.

In this case, it is conceivable to disperse the conductive particles not in the photocurable resin layer, but in an insulating resin layer having high viscosity at a heating temperature at the time of anisotropic conductive connection to suppress flow characteristics of the conductive particles at the time of anisotropic conductive connection and improve the workability when attaching the anisotropic conductive film to an electronic component. However, even if the conductive particles are precisely disposed in such an insulating resin layer, the conductive particles are carried away simultaneously when the resin layer undergoes flow movement at the time of anisotropic conductive connection and thus, it is difficult to sufficiently contrive an improvement of the conductive particle capturing performance in the terminal and a reduction of short circuits, and it is also difficult to maintain an initial precise disposition of the conductive particles after the anisotropic conductive connection and to hold a state in which the conductive particles are separated from each other.

Furthermore, in the case of the anisotropic conductive film having the three layer-structure described in Patent Documents 6 and 7, although there is no problem in the basic anisotropic conductive connection properties, due to using a three layer-structure, a reduction in the number of manufacturing steps is required from the perspective of reducing the manufacturing cost. Furthermore, the whole or a part of the first connection layer is significantly protruded along the outer shape of the conductive particles in the vicinity of the conductive particles on one side of the first connection layer and thus, the insulating resin layer itself that forms the first connection layer is not flat and the conductive particles are held in this protruded portion, and therefore, there is the concern that restrictions increase for a design to improve the holding of the conductive particles and the capturing performance by the terminal.

In contrast, an object of the present invention is to suppress, in a filler-containing film such as an anisotropic conductive film, unnecessary movement of fillers due to the flow movement of the resin layer during thermocompression bonding of the filler-containing film and to improve the conductive particle capturing performance and reduce short circuits, in particular, when the filler-containing film is configured as an anisotropic conductive film, without requiring a three layer-structure and without protruding the whole or a part of the resin layer along the outer shape of the fillers in the vicinity of the fillers of the resin holding the fillers such as conductive particles.

### Solution to Problem

The present inventor has obtained the following knowledge on a relationship between a surface shape of a resin layer in the vicinity of fillers and the viscosity of the resin layer in a filler-containing film including a filler dispersion layer in which fillers such as conductive particles are dispersed in a resin layer. That is, the following was discovered. Unlike the anisotropic conductive film described in Patent Document 5, in which the surface of the insulating resin layer (that is, the photocurable resin layer) on the side in which the conductive particles are embedded is flat, (i) when the fillers such as the conductive particles are exposed from the resin layer, and the surface of the resin layer around the fillers is made to tilt to become concave with respect to a tangent plane to a central portion of the surface of the resin layer between adjacent fillers, a part of the surface of the resin layer is absent and as a result, it is possible to reduce unnecessary resin that might obstruct bonding between the fillers and an article when the filler-containing film is bonded to an article by pressure bonding to bond the fillers to the article. Furthermore, (ii) when the fillers are embedded within the resin layer without being exposed from the resin layer, and fine undulations such as waves (hereinafter, simply referred to as undulations), recognized as traces of the embedded fillers, are formed with respect to the tangent plane to a central portion of the surface of the resin layer between adjacent fillers on the resin layer directly above the fillers, the amount of resin is low in concave portions of these undulations and thus, the fillers can be easily pushed by an article when the filler-containing film is bonded to an article by pressure bonding. (iii) Thus, when bonding two articles opposing each other by pressure bonding via the filler-containing film, the fillers held by the articles opposing each other and these articles are well connected, in other words, the filler capturing performance in the article and conformity of a disposition state of the fillers held between the articles before and after the pressure bonding are improved and further, product inspection and confirmation of a usable surface of the filler-containing film are facilitated. Additionally, it was discovered that these concavities in the resin layer can be formed by adjusting the viscosity of the resin layer into which the fillers are pushed when a filler dispersion layer is formed by the fillers being pushed into a resin layer.

The present invention has been contrived based on the knowledge mentioned above and provides a filler-containing film including a filler dispersion layer in which fillers are dispersed in a resin layer, wherein
a surface of the resin layer in the vicinity of the fillers includes inclinations or undulations with respect to a tangent plane to a central portion of the surface of the resin layer between adjacent fillers,
in the inclinations, the surface of the resin layer around the fillers is missing with respect to the tangent plane,
in the undulations, an amount of resin of the resin layer directly above the fillers is small compared to a case where the surface of the resin layer directly above the fillers is in the tangent plane, and
a CV value of the particle diameter of the fillers is not greater than 20%.

Furthermore, the present invention provides a method of producing a filler-containing film including a step of forming a filler dispersion layer in which fillers are dispersed in a resin layer, in which
the step of forming the filler dispersion layer includes a step of holding, on a surface of the resin layer, fillers having a CV value of the particle diameter not greater than 20%, and
a step of pushing the fillers held on the surface of the resin layer into the resin layer, and
in the step of holding the fillers on the surface of the resin layer, the fillers are dispersed on the surface of the resin layer, and, in the step of pushing the fillers into the resin layer, a viscosity of the resin layer, a pushing rate, or a temperature is adjusted during pushing of the fillers so that the surface of the resin layer in the vicinity of the fillers includes inclinations or undulations with respect to a tangent plane to a central portion of the surface of the resin layer between adjacent fillers, and in the inclinations, the surface of the resin layer around the fillers is missing with respect to the tangent plane, and in the undulations, the amount of resin of the resin layer directly above the fillers is small compared to a case where the surface of the resin layer directly above the fillers is in the tangent plane.

### Advantageous Effects of Invention

A filler-containing film according to the present invention includes a filler dispersion layer in which the fillers are dispersed in the resin layer. In this filler-containing film, the surface of the resin layer in the vicinity of the fillers that forms the surface of the filler dispersion layer includes inclinations that form concavities with respect to a tangent plane to a central portion of the surface of the resin layer between adjacent fillers or undulations with respect to the tangent plane. More specifically, when the fillers are exposed from the resin layer, the resin layer around the exposed fillers includes inclinations and when the fillers are embedded within the resin layer without being exposed from the resin layer, the resin layer directly above the fillers includes undulations. Note that the undulations may also exist when the fillers embedded in the resin layer come into contact with the surface of the resin layer at one point.

These inclinations and undulations are formed in the filler-containing film produced by the production method of the filler-containing film according to the present invention. That is, according to the production method of the filler-containing film of the present invention, the fillers are embedded in the resin layer by pushing the fillers into the resin layer. Thus, depending on an extent of embedding, the following cases are possible in the vicinity of the fillers: a case where the whole of each of the fillers is embedded in the resin layer and resin of the resin layer is present directly above the fillers (refer to FIG. 4 and FIG. 6, for example), a case where apical parts of the fillers are exposed from the resin layer and the resin layer in the vicinity of the fillers is drawn and moved into an inner part by the embedding of the fillers (refer to FIG. 1B and FIG. 2, for example), and a case where both cases described above co-exist. When describing from the point of the forming mechanism, the inclinations are formed around the fillers by the resin layer in the vicinity of the fillers being drawn and moved into the inner part by the embedding of the fillers. Furthermore, the undulations are a waviness formed on the surface of the resin layer directly above the fillers as traces of the embedding of the fillers when the whole of each of the fillers is embedded in the resin layer by the embedding of the fillers.

In this manner, the inclinations and the undulations are formed when the fillers are pushed into a resin layer having relatively high viscosity and thus, the presence of the inclinations or the undulations in the resin layer means that the resin layer has a high viscosity that allows for forming of the inclinations or the undulations. When the resin layer has high viscosity, unnecessary flow movement of the resin can be suppressed at the time of thermocompression bonding of the filler-containing film to an article, and the fillers can be prevented from being carried away by the flow movement of the resin. Furthermore, the resin layer having high viscosity does not hinder the bond between the article and the fillers, because resin that may obstruct the bond between the fillers and the article at the time of thermocompression bonding does not exist or exist at reduced amount.

Furthermore, when the resin layer is formed of a resin having high viscosity that allows for the forming of the inclinations or the undulations, an adhesion performance of the filler-containing film at the time of thermocompression bonding of the filler-containing film to an article can be maintained and unnecessary flow movement of the fillers can be suppressed at the time of thermocompression bonding by choosing a thin thickness of the resin layer and laminating the resin layer and a second resin layer having low viscosity compared to the resin layer. By choosing a thin resin layer, an effect of easily creating a margin in a heat pressing condition of a connection tool can also be achieved. This effect is more prominently produced when a variation in the particle diameter of the fillers is small. In the present invention, the CV value of the particle diameter of the fillers is not greater than 20% and thus, the above-described effect can be sufficiently produced.

Additionally, the inclinations or undulations of the resin layer are present in the vicinity of the fillers and thus, the quality of the dispersion state of the fillers can be easily determined during the production of the filler-containing film by observing the outer appearance of the filler-containing film.

When the above-described inclinations or the undulations are present on the resin layer and the filler-containing film is bonded by pressure bonding from the side of the filler of the filler-containing film to an article that is an adherend of the filler-containing film, an effect of reducing unnecessary flow movement of the resin layer can also be obtained. Thus, when the filler-containing film is configured as an anisotropic conductive film, for example, the influence of an unnecessary flow movement of the resin can be reduced to a minimum and a conductive particle capturing performance at the time of anisotropic conductive connection can be improved at the time of anisotropic conductive connection in which a first electronic component and a second electronic component are bonded via the anisotropic conductive film by thermocompression bonding.

Furthermore, compared to Patent Documents 6 and 7, the amount of resin in the vicinity of the fillers is reduced due to the inclinations. Thus, when bonding the filler-containing film to an article by pressure bonding, a flow movement of the resin is reduced and the fillers can be easily pushed to the article. Furthermore, when two articles are bonded by pressure bonding using the filler-containing film, the resin is less likely to hinder the fillers from being held and crushed to become flat. Furthermore, the flow movement of the resin that is related to causing an unnecessary flow movement of the fillers, is reduced due to the reduced amount of resin around the fillers by the inclinations. Therefore, the filler capturing performance in the article is improved and in particular, when the filler-containing film is configured as an anisotropic conductive film, the conduction reliability is improved by the improvement of the conductive particle capturing performance in the terminal.

When the undulations are formed on the insulating resin layer directly above the conductive particles embedded in the insulating resin layer, the pushing force from the terminal is easily exerted on the conductive particles at the time of anisotropic conductive connection, similarly to the case when the inclinations are formed. This is because the amount of resin directly above the conductive particles is reduced due to the concavities accompanying the undulations. Thus, the conductive particle capturing performance in the terminal and the conduction reliability are improved more than in a case where the resin is deposited in a flat manner directly above the conductive particles (refer to FIG. 8).

With the above-described filler-containing film according to the present invention, an unnecessary flow movement of the resin can be suppressed when the filler-containing film is bonded by pressure bonding to an article that is an adherend for the filler-containing film, and thus, an unnecessary flow movement of the fillers can also be suppressed and a bonding property between the fillers and the article is improved.

Thus, when the filler-containing film according to the present invention is configured as an anisotropic conductive film and this anisotropic conductive film is used to connect a first electronic component and a second electronic component, the conductive particles on the terminal are unlikely to be carried away. Thus, the conductive particle capturing performance is improved and the disposition of the conductive particles can be precisely controlled at the time of anisotropic conductive connection. Therefore, the filler-containing film can be used for connecting fine pitch electronic components having a terminal width of 6 μm to 50 μm and a space between terminals of 6 μm to 50 μm, for example. Furthermore, when the size of the conductive particles is less than 3 μm (for example, from 2.5 μm to 2.8 μm), electronic components can be connected without causing a short circuit, when an effective connection width of the terminals (a width of an overlapping portion in plan view from among the width of a pair of terminals opposing each other at the time of connection) is 3 μm or more and a smallest distance between terminals is 3 μm or more.

Furthermore, the disposition of the conductive particles can be precisely controlled and thus, when normal pitch electronic components are connected, the layout of a disposition area of the conductive particles and of an area where the number density of the conductive particles is changed, can be adapted to the layout of the terminals of various electronic components.

Furthermore, when the concavities due to the above-described undulations are formed in the resin layer directly above the fillers embedded in the resin layer in the filler-containing film according to the present invention, the positions of the fillers can be clearly understood from an observation of the outer appearance of the filler-containing film and thus, product inspection by the outer appearance is facilitated and identification of the front and back of the film surface is also facilitated. Thus, when bonding the filler-containing film to an article by pressure bonding, usable surface confirmation as to which film surface of the filler-containing film the article needs to be adhered, is facilitated. A similar advantage is obtained in the case of manufacturing the filler-containing film.

Additionally, according to the filler-containing film of the present invention, it is not always necessary that the resin layer is photocured for the fixation of the disposition of the fillers and thus, the resin layer may obtain tackiness when the filler-containing film is bonded to an article by thermocompression bonding. Thus, the workability is improved when bonding the filler-containing film to an article by temporary pressure bonding, and the workability is also improved when a second article is further bonded by pressure bonding after the temporary pressure bonding.

On the other hand, with a production method of the filler-containing film according to the present invention, the viscosity and the like of the resin layer when embedding the fillers in the resin layer is adjusted so that the above-described inclinations or undulations are formed on the resin layer. Thus, the filler-containing film according to the present invention that allows for the above-described effects can be easily produced.

### BRIEF DESCRIPTION OF DRAWINGS

FIG. 1A is a plan view illustrating the disposition of conductive particles in an anisotropic conductive film 10A according to an Example that is an aspect of a filler-containing film according to the present invention.

FIG. 1B is a cross-sectional view of the anisotropic conductive film 10A according to an Example that is an aspect of the filler-containing film according to the present invention.

FIG. 2 is a cross-sectional view of an anisotropic conductive film 10B according to an Example that is an aspect of the filler-containing film according to the present invention.

FIG. 3A is a cross-sectional view of an anisotropic conductive film 10C according to an Example that is an aspect of the filler-containing film according to the present invention.

FIG. 3B is a cross-sectional view of an anisotropic conductive film 10C′ according to an Example that is an aspect of the filler-containing film according to the present invention.

FIG. 4 is a cross-sectional view of an anisotropic conductive film 10D according to an Example that is an aspect of the filler-containing film according to the present invention.

FIG. 5 is a cross-sectional view of an anisotropic conductive film 10E according to an Example that is an aspect of the filler-containing film according to the present invention.

FIG. 6 is a cross-sectional view of an anisotropic conductive film 10F according to an Example that is an aspect of the filler-containing film according to the present invention.

FIG. 7 is a cross-sectional view of an anisotropic conductive film 10G according to an Example that is an aspect of the filler-containing film according to the present invention.

FIG. 8 is a cross-sectional view of an anisotropic conductive film 10X according to a Comparative Example of the filler-containing film according to the present invention.

FIG. 9 is a cross-sectional view of an anisotropic conductive film 10H according to an Example that is an aspect of the filler-containing film according to the present invention.

FIG. 10 is a cross-sectional view of an anisotropic conductive film 10I according to an Example that is an aspect of the filler-containing film according to the present invention.

FIG. 11A is a top surface picture of an anisotropic conductive film according to an Example that is an aspect of the filler-containing film according to the present invention.

FIG. 11B is a top surface picture of the anisotropic conductive film according to an Example that is an aspect of the filler-containing film according to the present invention.

### DESCRIPTION OF EMBODIMENTS

Below, an example of a filler-containing film according to the present invention will be described in detail while referring to the drawings. Note that in the drawings, identical reference signs indicate the same or similar constituents.

### Overall Configuration of Filler-Containing Film

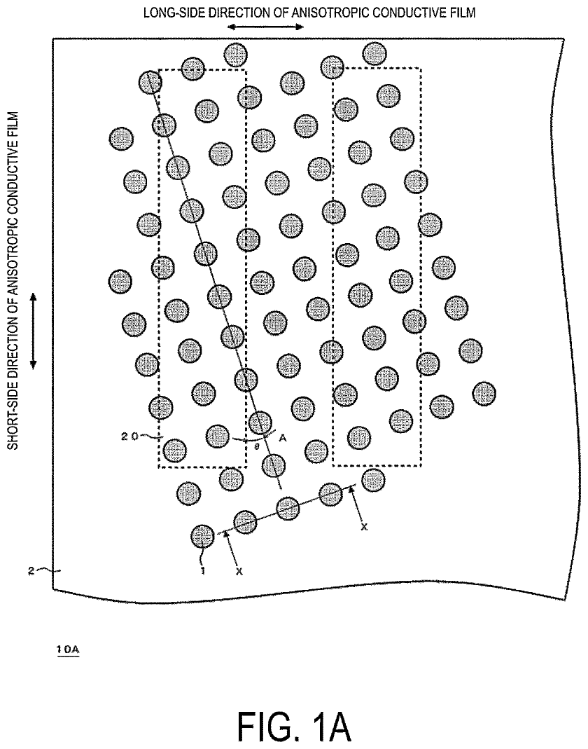

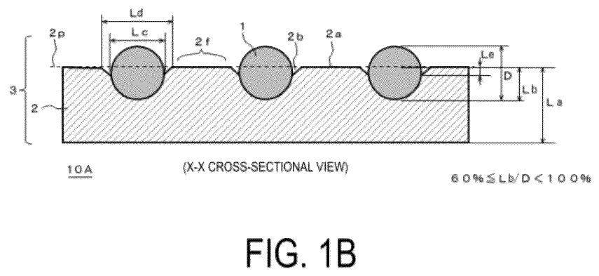

FIG. 1A is a plan view for describing a particle disposition in a filler-containing film 10A according to an Example of the present invention, and FIG. 1B is an X-X cross-sectional view thereof. The filler-containing film 10A is used as an anisotropic conductive film and conductive particles are dispersed as fillers 1 in an insulating resin layer 2.

The filler-containing film 10A can be shaped as a long film having a length of 5 m or more, for example, and can be configured as a wound body wound around a winding core.

The filler-containing film 10A is configured of a filler dispersion layer 3 and in the filler dispersion layer 3, the fillers 1 are dispersed regularly in an exposed state on one surface side of the resin layer 2. In a plan view of the film, the fillers 1 do not contact each other and the fillers 1 are also regularly dispersed in a film thickness direction without overlapping with each other to form a single-layered filler layer in which the fillers 1 are similar in positions of the film thickness direction.

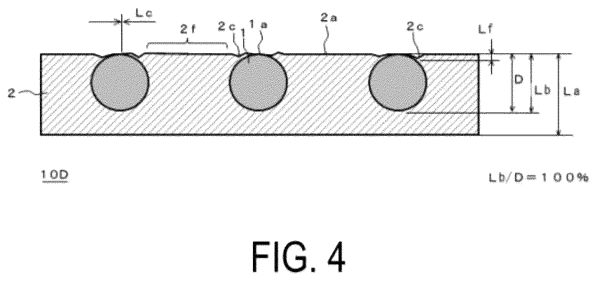

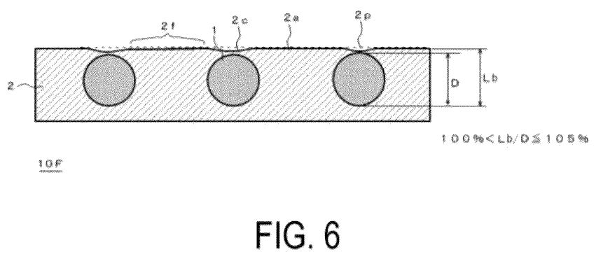

In the vicinity of the individual fillers 1, on a surface 2a of the resin layer 2 around the fillers 1, an inclination 2b is formed with respect to a tangent plane 2p to a central portion of the surface of the resin layer 2 between adjacent fillers. Note that, as described below, in the filler-containing film according to the present invention, undulations 2c may be formed on a surface of the resin layer directly above the fillers 1 embedded in the resin layer 2 (FIG. 4, FIG. 6).

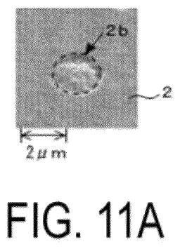

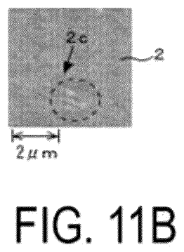

In the present invention, “inclination” means a state where the flatness of the surface of the resin layer 2 is lost in the vicinity of the fillers 1 or around the fillers 1 and the amount of resin is reduced due to a part of the resin layer with respect to the tangent plane 2p missing. On the other hand, “undulations” means a state where waviness is present on the surface of the resin layer directly above the conductive particles and the resin is reduced due to the existence of a concave portion accompanying the waviness. The “undulations” can be recognized by comparing, on the surface of the resin layer, a portion corresponding to a part directly above the fillers with a flat surface part between the fillers (2f in FIGS. 1B, 4, and 6. Outside of 2b in FIG. 11A, and Outside of 2c in FIG. 11B.). Note that a starting point of the undulations may exist as a inclination.

### Dispersion State of Fillers

A dispersion state of the fillers according to the present invention includes both a state where the fillers 1 are randomly dispersed and a state where the fillers 1 are dispersed in a regular disposition. In both cases, it is preferable, from the point of suppressing unnecessary flow movement of the fillers when bonding the filler-containing film by thermocompression bonding to an article that is an adherend of the filler-containing film, and particularly preferable from the point of a capturing stability of the conductive particles at a terminal of an electronic component when the filler-containing film is configured as an anisotropic conductive film, that the fillers 1 are similar in the positions in the film thickness direction. Here, the fillers 1 being similar in the positions in the film thickness direction is not limited to the fillers 1 being positioned at a certain depth in the film thickness direction, and a state where the conductive particles exist at a boundary surface on front side or back side of the resin layer 2 or at the vicinity thereof is also included.

In order to uniform the optical, mechanical, and electrical characteristics of the filler-containing film, it is preferable that the fillers 1 are arranged in regular arrangements in a plan view of the film, especially for achieving both capturing stability of the conductive particles at the terminal and suppression of short circuits when the fillers are used as conductive particles and the filler-containing film is configured as an anisotropic conductive film. An aspect of the arrangement is not particularly limited; in a plan view of the film, it is possible to select, for example, a square lattice arrangement, as illustrated in FIG. 1A. Other aspects of regular arrangements of the fillers include lattice arrangements such as a rectangular lattice, a rhombic lattice, a hexagonal lattice, or a triangular lattice. A plurality of different types of lattices may be combined. As an aspect of an arrangement of the fillers, particle rows in which the fillers are arranged linearly at a prescribed spacing may be arranged at a prescribed spacing. Furthermore, an aspect may be selected in which omissions of fillers exist regularly in a prescribed direction of the film.

By selecting a regular arrangement of a lattice form and the like in which the fillers 1 do not come into contact with each other, equal pressure can be applied to each of the fillers 1 when pressure-bonding the filler-containing film to an article and variations in the connection state can be reduced. Furthermore, by repeatedly letting omissions of fillers exist in a long-side direction of the film, or by gradually increasing or decreasing positions where fillers are omitted in the long-side direction of the film, batch management is possible and traceability (a property for allowing tracing) can be added to the filler-containing film and a connection structure using the filler-containing film. This is also useful for forgery prevention, authenticity determination, prevention of unauthorized utilization, and the like, of a filler-containing film or a connection structure using the filler-containing film.

Thus, when the filler-containing film is configured as an anisotropic conductive film, variations in the conduction resistance when the anisotropic conductive film is used to anisotropically conductively connect a first electronic component and a second electronic component can be reduced by selecting a regular arrangement of the conductive particles in which the conductive particles do not come into contact with each other. Note that, it is possible to determine whether the fillers are regularly arranged, by observing whether a prescribed disposition of the fillers is repeated in the long-side direction of the film, for example. Furthermore, when the filler-containing film is configured as an anisotropic conductive film, it is even more preferable that the conductive particles are regularly arranged in the plan view of the film and that positions of the conductive particles in a film thickness direction are similar, to achieve both capturing stability of the conductive particles at the terminal and suppression of short circuits when the anisotropic conductive film is used to anisotropically conductively connect the first electronic component and the second electronic component.

On the other hand, when the space between terminals of connected electronic components is large and thus, short circuits do hardly occur, the conductive particles may not be regularly arranged, but the conductive particles may be dispersed randomly, as long as no hindrance for conduction is involved.

When the fillers are regularly arranged, a lattice axis or an arrangement axis of the arrangements may be in parallel with the long-side direction of the filler-containing film or a direction orthogonal to the long-side direction, or may intersect with the long-side direction of the filler-containing film, which may be determined in accordance with the article to which the filler-containing film is pressure-bonded. For example, when the filler-containing film is configured as an anisotropic conductive film, the lattice axis or the arrangement axis of the regularly arranged conductive particles may be determined in accordance with a terminal width, terminal pitch, layout, and the like, of a terminal connected via the anisotropic conductive film. More specifically, when the filler-containing film is configured as an anisotropic conductive film for a fine pitch, as illustrated in FIG. 1A, a lattice axis A of conductive particles 1 intersects obliquely with the long-side direction of an anisotropic conductive film 10A, and an angle θ formed by the long-side direction of a terminal 20 (short-side direction of the film) to be connected via the anisotropic conductive film 10A and the lattice axis A is preferably from 6° to 84° and more preferably, from 11° to 74°.

A distance between the fillers in the filler-containing film can also be determined depending on the connected article, and thus, when the filler-containing film is configured as an anisotropic conductive film, an interparticle distance of the conductive particles that are the fillers 1 can be appropriately determined in accordance with a size and a terminal pitch of the terminal connected by the anisotropic conductive film. For example, when the anisotropic conductive film is applied to a fine pitch chip on glass (COG), a closest distance between fillers (that is, a minimum interparticle spacing) is preferably 0.5 times or more the conductive particle diameter D, and is more preferably, larger than 0.7 times the conductive particle diameter D, in order to prevent the occurrence of short circuits. On the other hand, an upper limit of the closest distance between fillers can be decided according to a purpose of the filler-containing film, for example, for ease of manufacturing of the filler-containing film, the minimum interparticle spacing can be preferably 100 times or less, and more preferably, 50 times or less the conductive particle diameter D. Furthermore, from the point of a conductive particle 1 capturing performance in the terminal at the time of anisotropic conductive connection, the minimum interparticle spacing is preferably 4 times or less, and more preferably, 3 times or less the conductive particle diameter D.

Furthermore, in the filler-containing film according to the present invention, an area occupancy ratio of the fillers calculated by the following formula is preferably 0.3% or more so that an effect from containing the fillers is expressed.

$$Area occupancy ratio ( \% ) = [ Number density of fillers in plan view ] * [ \text{} Average plan view area of one filler ] * 100$$

This area occupancy ratio is an indicator of a thrust needed for a pressing jig for pressure-bonding the filler-containing film to an article. As described later, from the point of suppressing the thrust needed for the pressing jig for pressure-bonding the filler-containing film to the article, the area occupancy ratio is preferably 35% or less, more preferably, 30% or less.

Here, as a measurement area of the number density of the fillers, it is preferable that rectangular areas for which one side is 100 μm or more are randomly provided at a plurality of positions (preferably five or more positions, more preferably 10 or more positions) to form a measurement area having a total area of 2 mm² or more. The size and number of the individual areas may be appropriately adjusted depending on a state of the number density. As an example of a case where the number density of an anisotropic conductive film for use in fine pitch is relatively high, the number density in any 200 positions (2 mm²) each having a 100 μm×100 μm surface area selected on the filler-containing film is measured using image observation by a metallurgical microscope or the like, and by averaging the measurement result, the “number density of the fillers in plan view” in the above-described formula can be obtained. When the filler-containing film is configured as an anisotropic conductive film, a surface area of 100 μm×100 μm is a surface area on which one or more bumps exist in a connection target having a space between bumps of 50 μm or less.

Note that, as long as the area occupancy ratio is within the above-described range, the value of the number density is not particularly limited, however, when the filler-containing film is configured as an anisotropic conductive film, from a practical standpoint, the number density may be 30 particles/mm² or more, preferably 150 to 70000 particles/mm², and particularly in the case of use in fine pitch, the number density is preferably 6000 to 42000 particles/mm², more preferably 10000 to 40000 particles/mm², and even more preferably 15000 to 35000 particles/mm².

Other than by observation using a metallurgical microscope, as described above, the number density of the fillers may be evaluated by measuring an image observation by using an image analysis software (for example, WinROOF, Mitani Corporation). The observation method and the measurement procedure are not limited to the ones mentioned above.

Furthermore, the average of the plan view area of one filler can be evaluated by measuring an image of the film surface observed using a metallurgical microscope or an electron microscope such as SEM and the like. An image analysis software may also be used. The observation method and the measurement procedure are not limited to the ones mentioned above.

As described above, the area occupancy ratio is preferably 35% or less, more preferably 30% or less. The reason for this is described below. Conventionally, in order to accommodate fine pitch, the interparticle distance of conductive particles in an anisotropic conductive film is reduced as long as no short circuit occurs, and thus, the number density is increased. However, in accordance with an increase of the total connection area for one electronic component due to an increase in the number of terminals in the electronic component, the number density of the conductive particles is increased, so that the thrust needed for the pressing jig for bonding the anisotropic conductive film to the electronic component by thermocompression bonding increases, and thus, there is a concern in that the pressing force in conventional pressing jigs is not sufficient. Such a problem of required thrust of pressing jigs is not limited to anisotropic conductive films, but is common to filler-containing films in general. In this context, in the present invention, the area occupancy ratio is preferably 35% or less, more preferably 30% or less, as described above, and thus, the thrust needed for the pressing jig for bonding the filler-containing film to an article by thermocompression bonding is suppressed.

### Filler

The fillers 1 in the present invention can be appropriately selected according to the purpose of the filler-containing film, in accordance with a performance demanded for the purpose, such as a hardness, an optical performance, and the like, from known inorganic fillers (metals, metal oxides, metal nitrides, and the like), organic fillers (resin particles, rubber particles, and the like), and fillers in which organic materials and inorganic materials co-exist (for example, particles in which the core is formed of a resin material and the surface is metal-plated (metal-coated resin particles), particles in which insulating microparticles are attached to the surface of conductive particles, particles in which an insulating process is performed on the surface of conductive particles, and the like). For example, a silica filler, a titanium oxide filler, a styrene filler, an acryl filler, a melamine filler, various types of titanates, and the like can be used in an optical film and a matte film. In films for capacitors, titanium oxide, magnesium titanate, zinc titanate, bismuth titanate, lanthanum oxide, calcium titanate, strontium titanate, barium titanate, barium zirconate titanate, and lead zirconate titanate, as well as mixtures thereof and the like can be used. Adhesive films can contain polymer-based rubber particles, silicon rubber particles, and the like. Anisotropic conductive films contain conductive particles. Examples of the conductive particles include particles of metals such as nickel, cobalt, silver, copper, gold, or palladium, particles of alloys such as solder, metal-coated resin particles, metal-coated resin particles in which insulating microparticles are attached on the surface, and the like. A combination of two or more materials may also be used. Among these, the metal-coated resin particles are preferred from the point of stability of conduction performance, as a contact with the terminal can be easily maintained due to the repulsion of the resin particles after connection. Furthermore, an insulating process that does not involve any negative influence for the conduction property may be performed on the surface of the conductive particles by a known technology. The fillers exemplified for the different purposes mentioned above are not limited to these purposes and a filler-containing film for another purpose may be included, as needed. Furthermore, two or more types of fillers may be used in combination in the filler-containing film for each purpose, as needed.

The shape of the fillers is determined in accordance with the purpose of the filler-containing film by appropriate selection from a spherical shape, an elliptical spherical shape, a column shape, a needle shape, or a combination of these, and the like. The spherical shape is preferred from the point of easily maintaining a uniform state in which confirmation of the filler disposition is easy. It is particularly preferable that the conductive particles in the anisotropic conductive film are substantially spherical. When the conductive particles are substantially spherical and an anisotropic conductive film is produced in which arrangements of conductive particles are formed by using, for example, a transfer mold as disclosed in JP 2014-60150 A, the conductive particles can roll smoothly on the transfer mold. Consequently, the conductive particles can be filled into predetermined positions on the transfer mold with high precision. Thus, the conductive particles can be precisely disposed.

Herein, being substantially spherical means the sphericity as calculated using the following equation ranges from 70 to 100:

$$Sphericity = \{ 1 - ( So - Si ) / So \} \times 100$$

In the equation, So is an area of a circumscribed circle of the filler in a planar image of the filler, and Si is an area of an inscribed circle of the filler in the planar image of the filler.

This calculation method is preferably performed in the following manner. Planar images of the fillers within a surface field of view of the filler-containing film and in a cross section thereof are taken. In each of the planar images, 100 or more (preferably 200 or more) of the fillers are randomly selected and the areas of the circumscribed circles and the inscribed circles of the fillers are measured. The average of the areas of the circumscribed circles and the average of the areas of the inscribed circles are determined to be designated as So and Si described above respectively. In both the surface field of view and the cross section, it is preferable that the sphericities of the fillers are within the range described above. The difference in sphericities of the fillers between in the surface field of view and in the cross section is preferably not greater than 20, and more preferably not greater than 10. The inspection of filler-containing films in the production process is performed using mainly the surface field of view, whereas the detailed quality determination after thermocompression bonding to an article is performed using both the surface field of view and the cross section. Thus, it is preferable that the difference in sphericity be as small as possible. Note that, when sphericity for fillers alone is measured, a wet-type flow particle diameter/shape analyzing device FPIA-3000 (from Malvern Panalytical Ltd.) can be used.

The particle diameter D of the fillers is appropriately determined in accordance with the purpose of the filler-containing film. For example, the particle diameter D in the anisotropic conductive film preferably ranges from 1 um to 30 μm, and more preferably from 2.5 μm to 9 μm. The reason for this is to accommodate variations in the height of the wiring, suppress an increase in conduction resistance, and suppress the occurrence of a short circuit. According to a connection target, the particle diameter D may be larger than 9 μm.

Note that the particle diameter D of the fillers before dispersion in the resin layer 2 can be measured using a common particle size distribution analyzer, and the average particle diameter can also be determined using the particle size distribution analyzer. The FPIA-3000 (from Malvern Panalytical Ltd.) can be named as an example of the particle size distribution analyzer. On the other hand, the particle diameter D of the fillers in the filler-containing film can be determined by observations using electron microscopes such as SEM. In this case, it is preferable that the number of samples for measuring the particle diameter D is 200 or more. Furthermore, when the shape of the fillers is not spherical, the longest length or a diameter of a shape approximating a spherical shape can be used as the particle diameter D of the fillers.

In the present invention, the variation of the particle diameter D of the fillers in the filler-containing film has a CV value (standard deviation/mean) of 20% or less. By using a CV value of 20% or less, it is easier to exert even pressure on the filler-containing film during pressure bonding of the filler-containing film to an article and especially when the fillers are arranged, a local concentration of the pushing force can be prevented, and thus, a contribution to the stability of the connection is possible. Furthermore, after the connection is made, a precise evaluation of the connection state can be made by indentation. Specifically, when the filler-containing film is configured as an anisotropic conductive film, the connection state can be precisely confirmed by indentation for both large terminal sizes (FOG and the like) and small terminal sizes (COG and the like) in an inspection after establishing an anisotropic conductive connection between the anisotropic conductive film and an electronic component. Accordingly, the inspection after establishing the anisotropic conductive connection is facilitated and an improvement in the efficiency of the connection process can be expected.

Here, variations in the particle diameter can be calculated using a image type particle image analyzer, for example. The particle diameter of the fillers, as raw material particles for the filler-containing film, that is, particles not yet included in the filler-containing film, can also be determined by using the above-described wet-type flow particle imaging instrument FPIA-3000 (from Malvern Panalytical Ltd.). In this case, the variations for the fillers alone can be precisely grasped by measuring 1000 particles or more, preferably 3000 particles or more, even more preferably 5000 particles or more of the fillers. When the fillers are disposed in the filler-containing film, the particle diameter can be determined by planar images or cross-sectional images as with the sphericity described above.

### Resin Layer

### Viscosity of Resin

The minimum melt viscosity of the resin layer 2 according to the present invention is not particularly limited, and can be determined appropriately in accordance with a purpose of the filler-containing film, a production method of the filler-containing film, and the like. For example, as long as the above-described inclinations 2b and the undulations 2c can be formed, depending on the production method of the filler-containing film, the minimum melt viscosity of about 1000 Pa*s can be applied. However, when a method of holding the fillers at a prescribed disposition on the surface of the resin layer and pushing the fillers into the resin layer is performed as the production method of the filler-containing film, the minimum melt viscosity of the resin is preferably not less than 1100 Pa*s from the perspective of ensuring that the resin layer enables film formation.

Furthermore, as described later in the production method of the filler-containing film, from the perspective of forming the inclinations 2b around the exposed portions of the fillers 1 pushed into the resin layer 2 as illustrated in FIG. 1B and the like, or from the perspective of forming the undulations 2c on the surface of the resin layer directly above the fillers 1 pushed into the resin layer 2 as illustrated in FIG. 4 and FIG. 6, the minimum melt viscosity is preferably 1500 Pa*s or more, more preferably 2000 Pa*s or more, even more preferably from 3000 to 15000 Pa*s, and particularly preferably from 3000 to 10000 Pa*s. The minimum melt viscosity may be determined in the following manner, for example. A rotary rheometer (TA Instruments) is used, a measurement pressure of 5 g is maintained to be constant, and a measurement plate of 8 mm in diameter is used. More specifically, the minimum melt viscosity may be determined within a temperature range from 30 to 200° C., by using a rate of temperature increase of 10° C./min, a measurement frequency of 10 Hz, and a load variation of 5 g on the measurement plate.

By using a high viscosity of 1500 Pa*s or more as the minimum melt viscosity of the resin layer 2, unnecessary movement of the fillers can be suppressed during thermocompression bonding of the filler-containing film to an article and especially when the filler-containing film is configured as an anisotropic conductive film, it can be prevented that the conductive particles 1 to be held between the terminals at the time of anisotropic conductive connection, are being carried away by a flow movement of the resin.

Furthermore, when the filler dispersion layer 3 of the filler-containing film 10A is formed by pushing the fillers 1 into the resin layer 2, the resin layer 2 into which the fillers 1 are pushed is configured as one of the following: a viscous body of high viscosity in which the inclinations 2b (FIG. 1B) can be formed on the resin layer 2 around the fillers 1 by plastic deformation of the resin layer 2 at the time of pushing the fillers 1 into the resin layer 2 so that the fillers 1 are exposed from the resin layer 2; or a viscous body of high viscosity in which the undulations 2c (FIG. 4 and FIG. 6) are formed on the surface of the resin layer 2 directly above the fillers 1 during the process of pushing the fillers 1 into the resin layer 2 so that the fillers 1 are embedded in the resin layer 2 without being exposed from the resin layer 2. Thus, the lower limit of the viscosity of the resin layer 2 at 60° C. is preferably not less than 3000 Pa*s, more preferably not less than 4000 Pa*s, and even more preferably not less than 4500 Pa*s, and the upper limit is preferably not greater than 20000 Pa*s, more preferably not greater than 15000 Pa*s, and even more preferably not greater than 10000 Pa*s. This measurement is made with the same measurement method as in the case of the minimum melt viscosity, and the viscosity can be determined by extracting the value at a temperature of 60° C.

Specifically, the viscosity of the resin layer 2 at the time of pushing the fillers 1 into the resin layer 2 is selected in accordance with the shape and the depth of the inclinations 2b and the undulations 2c to be formed, and the lower limit of the viscosity of the resin layer 2 is preferably not less than 3000 Pa*s, more preferably not less than 4000 Pa*s, and even more preferably not less than 4500 Pa*s, and the upper limit is preferably not greater than 20000 Pa*s, more preferably not greater than 15000 Pa*s, and even more preferably not greater than 10000 Pa*s. In addition, such a viscosity is achieved at a temperature of preferably from 40 to 80° C. and more preferably from 50 to 60° C.

By forming, as described above, the inclinations 2b (FIG. 1B) around the fillers 1 exposed from the resin layer 2, the resistance received from the resin layer 2 to the flattening of the fillers 1 that occurs during the pressure bonding of the filler-containing film to an article is reduced, compared to a case in which no inclination 2b is provided. Thus, when the filler-containing film is configured as an anisotropic conductive film, the conductive particles can be easily held by the terminal at the time of anisotropic conductive connection and thus, the conductive performance is improved and further, the conductive particle capturing performance in the terminal is improved.

It is preferable that the inclinations 2b are formed along an outer shape of the exposed portion of the fillers. The reason for this is that, apart from an effect of the inclinations being more easily expressed during connection, the fillers can be easier recognized and thus, a product inspection of the filler-containing film during manufacturing and the like can be easily performed.

Furthermore, the undulations 2c (FIG. 4 and FIG. 6) are formed on the surface of the resin layer 2 directly above the fillers 1 which are embedded into the resin layer 2 without being exposed, and thus, similarly to the inclinations, during pressure bonding to an article, a pushing force from the article is easily exerted on the fillers. Moreover, due to the undulations including concave, the amount of resin directly above the fillers is reduced compared to a case where the resin directly above the fillers is flat and thus, the resin directly above the fillers is easily removed during the pressure bonding and an excellent connection state between the article and the fillers is obtained. In particular, when the filler-containing film is configured as an anisotropic conductive film, the terminal and the conductive particles can easily come into contact at the time of anisotropic conductive connection and thus, the conductive particle capturing performance in the terminal is improved and the conduction reliability is improved.

A part of the inclinations 2b and the undulations 2c may be lost due to heat-pressing to the resin layer and the like, however, this is included in the present invention. Furthermore, the fillers are exposed at one position on the surface of the resin layer and a inclination or an undulation may exist around this one position, however, this is also included in the present invention. These aspects may be selected appropriately in accordance with the purpose of the filler-containing film and the article to be bonded by thermocompression bonding. That is, a degree of freedom for designing the filler-containing film of the present invention is high, and as needed, the levels of the inclinations or the undulations can be reduced or the inclinations or the undulations can be partially eliminated.

### Layer Thickness of Resin Layer

In the filler-containing film according to the present invention, it is preferable that a ratio between a layer thickness La of the resin layer 2 and the particle diameter D of the fillers (La/D) is from 0.6 to 10. Here, the particle diameter D of the fillers refers to the average particle diameter of the fillers. When the layer thickness La of the resin layer 2 is too large, a displacement of the fillers tends to occur during pressure bonding of the filler-containing film to an article. Thus, when the filler-containing film is configured as an optical film, variations of the optical properties occur. Furthermore, when the filler-containing film is configured as an anisotropic conductive film, the conductive particle capturing performance in the terminal that is anisotropically conductively connected to the electronic component is reduced. This tendency is marked when La/D exceeds 10. Thus, La/D is more preferably not greater than 8 and even more preferably not greater than 6. In contrast, when the layer thickness La of the resin layer 2 is too small and La/D is less than 0.6, it becomes difficult to keep the fillers 1 in a prescribed particle dispersion state or a prescribed arrangement with the resin layer 2. In particular, when the terminal to be connected is a high-density COG in the case of an anisotropic conductive film as the filler-containing film, the ratio (La/D) between the layer thickness La of the insulating resin layer 2 and the conductive particle diameter D is preferably from 0.6 to 3, more preferably from 0.8 to 2. On the other hand, when the filler-containing film is an anisotropic conductive film, a lower limit of the ratio (La/D) may be 0.25 or more, when the risk that a short circuit occurs can be assumed to be low according to a bump layout and the like of the electronic component to be connected.

### Composition of Resin Layer

The resin layer 2 according to the present invention can be formed from thermoplastic resin compositions, resin compositions of high viscosity and adhesiveness, or curable resin compositions. The resin composition for configuring the resin layer 2 is selected appropriately in accordance with the purpose of the filler-containing film and further, whether the resin layer 2 is given an insulating property is also determined in accordance with the purpose of the filler-containing film.

Here, the curable resin composition can be formed, for example, from a thermo-polymerizable composition containing a thermo-polymerizable compound and a thermal polymerization initiator. A photopolymerization initiator may be included in the thermo-polymerizable composition, as needed.

When a thermal polymerization initiator and a photopolymerization initiator are used in combination, a thermo-polymerizable compound functioning also as the photopolymerizable compound may be used, or a photopolymerizable compound may be included separately from the thermo-polymerizable compound. Preferably, the photopolymerizable compound is included separately from the thermo-polymerizable compound. For example, a cationic curing initiator may be used as the thermal polymerization initiator, an epoxy resin may be used as the thermo-polymerizable compound, a photoradical polymerization initiator may be used as the photopolymerization initiator, and an acrylate compound may be used as a photopolymerizable compound.

A plurality of types of photopolymerization initiators which react with light of different wavelengths may be included. As a result, different wavelengths may be used during the manufacturing of the filler-containing film for the photocuring of a resin for forming a film from the resin layer, and the photocuring of a resin when the filler-containing film is pressure-bonded to an article.

When photocuring is performed during the manufacturing of the filler-containing film, the whole photopolymerizable compound or a part of the photopolymerizable compound included in the resin layer can be photocured. The disposition of the fillers 1 in the resin layer 2 is maintained or fixed by this photocuring. Thus, when the filler-containing film is configured as an anisotropic conductive film, the suppression of a short circuit and an improvement of the conductive particle capturing performance in the terminal can be expected. Furthermore, the viscosity of the resin layer may be appropriately adjusted by this photocuring during the manufacturing process of the filler-containing film.

The compounded amount of the photopolymerizable compound in the resin layer is preferably not greater than 30 mass %, more preferably not greater than 10 mass %, and even more preferably less than 2 mass %. This is because when the amount of the photopolymerizable compound is too large, the thrust required for pressing during pressure bonding of the filler-containing film to an article increases.

Examples of the thermo-polymerizable composition include thermal radical polymerizable acrylate-based compositions containing a (meth)acrylate compound and a thermal radical polymerization initiator and thermal cationic polymerizable epoxy compositions containing an epoxy compound and a thermal cationic polymerization initiator. A thermal anionic polymerizable epoxy composition containing a thermal anionic polymerization initiator may be used instead of a thermal cationic polymerizable epoxy composition containing a thermal cationic polymerization initiator. Furthermore, unless problems are to be expected, a plurality of types of polymerizable compounds may be used in combination. An example of combined use is the combined use of a thermal cationic polymerizable compound and a thermal radical polymerizable compound.

Herein, the (meth)acrylate compound may be an existing known thermally polymerizable (meth)acrylate monomer. Examples thereof include monofunctional (meth)acrylate-based monomers and polyfunctional, that is, two or more functional, (meth)acrylate-based monomers.

Examples of the thermal radical polymerization initiator may include organic peroxides and azo compounds. In particular, organic peroxides may be preferred because they do not produce nitrogen, which can induce bubbles.

The amount of the thermal radical polymerization initiator to be used preferably ranges from 2 to 60 parts by mass, and more preferably from 5 to 40 parts by mass, per 100 parts by mass of a (meth)acrylate compound. When the amount is too small, insufficient curing will occur. When the amount is too large, the product life will decrease.

Examples of the epoxy compound may include bisphenol A type epoxy resins, bisphenol F type epoxy resins, novolak type epoxy resins, modifications of these epoxy resins, and cycloaliphatic epoxy resins. Two or more of these may be used in combination. An oxetane compound may be used in addition to the epoxy compound.

The thermal cationic polymerization initiator may be a known thermal cationic polymerization initiator for epoxy compounds. Examples of the initiator include iodonium salts, sulfonium salts, phosphonium salts, and ferrocenes, which generate acid via heat. In particular, aromatic sulfonium salts, which exhibit good temperature latency, may be preferred.

The amount of the thermal cationic polymerization initiator to be used preferably ranges from 2 to 60 parts by mass, and more preferably from 5 to 40 parts by mass, per 100 parts by mass of an epoxy compound. When the amount is too small, insufficient curing tends to occur. When the amount is too large, the product life tends to decrease.

A known curing agent that is ordinarily used can be used as the thermal anionic polymerization initiator. Examples include organic acid dihydrazide, dicyandiamide, amine compounds, polyamide amine compounds, cyanate ester compounds, phenol resins, acid anhydride, carboxylic acid, tertiary amine compounds, imidazole, Lewis acid, Bronsted acid salts, polymercaptan-based curing agents, urea resins, melamine resins, isocyanate compounds, and block isocyanate compounds. One type of these may be used alone, or two or more types may be used in combination. Of these, it is preferable to use a microcapsule-type latent curing agent formed by using an imidazole-modified substance as a core and covering the surface thereof with polyurethane.

The thermo-polymerizable composition preferably contain a film forming resin and a silane coupling agent. Examples of the film forming resin may include, phenoxy resins, epoxy resins, unsaturated polyester resins, saturated polyester resins, urethane resins, butadiene resins, polyimide resins, polyamide resins, and polyolefin resins. Two or more of these may be used in combination. Among these, phenoxy resins may be preferred from the standpoints of film forming ability, processability, and connection reliability. It is preferable that the average molecular weight is 10000 or more. Examples of the silane coupling agent may include epoxy silane coupling agents and acrylic silane coupling agents. These silane coupling agents are mostly alkoxy silane derivatives.

The thermo-polymerizable composition may also contain, separately from the fillers 1 described above, insulating fillers to adjust the melt viscosity. Examples of this include silica powders and alumina powders. The insulating fillers are preferably fillers having a fine particle diameter from 20 to 1000 nm, and the compounded amount is preferably from 5 to 50 parts by mass per 100 parts by mass of the thermo-polymerizable compound (photopolymerizable compound) such as an epoxy compound. The insulating fillers contained separately from the fillers 1 are preferably used when the filler-containing film is used as an anisotropic conductive film, however, depending on the purpose, the insulating fillers may not be contained, but fine, conductive fillers may be contained, for example. When the filler-containing film is configured as an anisotropic conductive film, smaller insulating fillers (so-called nano-fillers) different from the fillers 1 can be appropriately contained in the resin layer constituting the filler dispersion layer, as needed.

The filler-containing film according to the present invention may also contain fillers, softeners, promoters, antioxidants, colorants (pigments and dyes), organic solvents, and ion scavengers, separately from the above-described insulating or conductive fillers.

### Position of Fillers in Thickness Direction of Resin Layer

As described above, in the filler-containing film according to the present invention, the positions of the fillers 1 in the thickness direction of the resin layer 2 may be so that the fillers 1 are exposed from the resin layer 2 or that the fillers 1 are embedded in the resin layer 2 without being exposed. However, the ratio between a distance Lb from the tangent plane 2p to a central portion between adjacent fillers to the deepest part of the fillers (hereinafter, referred to as embedded amount) and the particle diameter D of the fillers (Lb/D) (hereinafter, referred to as embedding percentage) is preferably from 60% to 105%.

By selecting an embedding percentage (Lb/D) of 60% or more, the fillers 1 can be maintained in a prescribed particle dispersion state or a prescribed arrangement with the resin layer 2. Furthermore, by selecting an embedding percentage of 105% or less, the amount of resin of the resin layer that causes the fillers at the time of pressure bonding of the filler-containing film to an article to perform unnecessary movement can be reduced.

Note that a numeric value of the embedding percentage (Lb/D) in the present invention means that 80% or more, preferably 90% or more, and even more preferably 96% or more of the total number of fillers included in the filler-containing film exhibit that numeric value of the embedding percentage (Lb/D). Thus, the embedding percentage being from 60% to 105% means that 80% or more, preferably 90% or more, and even more preferably 96% or more of the total number of fillers included in the filler-containing film have the embedding percentage being from 60% to 105%.

When the embedding percentage (Lb/D) of all fillers is configured uniformly in this manner, a pushing weight is evenly applied to the fillers during pressure bonding of the filler-containing film to an article. Thus, uniformity of quality such as optical properties and mechanical properties can be ensured for a film-adhered body obtained from bonding the filler-containing film to an article by pressure bonding. Furthermore, when the filler-containing film is configured as an anisotropic conductive film, an excellent capturing state of the conductive particles in the terminal is obtained at the time of anisotropic conductive connection and the conduction reliability is improved.

The embedding percentage (Lb/D) can be determined by randomly selecting 10 or more positions on a surface area of an area not less than 30 mm² of the filler-containing film, observing a part of this film cross section by SEM imaging, and measuring a total of 50 or more fillers. The determination may be done by measuring 200 or more fillers to increase the accuracy.

Furthermore, in the measurement of the embedding percentage (Lb/D), measurement can be performed for a certain number of fillers at once by adjusting a focus on a surface field of view image. Alternatively, a laser-type displacement determination sensor (manufactured by Keyence and the like) may be used for the measurement of the embedding percentage (Lb/D).

### Aspect of Embedding Percentage 60% or More to Less Than 100%

A specific example of an embedding aspect of the fillers 1 in which the embedding percentage (Lb/D) is from 60% to 105% may include, an aspect in which the fillers 1 are embedded with an embedding percentage from 60% to less than 100% so as to be exposed from the resin layer 2, such as in the filler-containing film 10A illustrated in FIG. 1B. In the filler-containing film 10A, a portion of the surface of the resin layer 2 and the vicinity of the portion that are in contact with the fillers 1 exposed from the resin layer 2 include the inclinations 2b that are formed in a concave shape with respect to the tangent plane 2p to the central portion of the surface 2a of the resin layer between adjacent fillers, and these concavities form ridges approximately along the outer shape of the fillers.

To form these inclinations 2b or undulations 2c (FIG. 4 and FIG. 6), when the filler-containing film is manufactured by pushing the fillers 1 into the resin layer 2, the lower limit of the viscosity of the resin layer 2 at the time of the pushing the fillers 1 into the resin layer 2 is preferably not less than 3000 Pa*s, more preferably not less than 4000 Pa*s, and even more preferably not less than 4500 Pa*s, and the upper limit is preferably not greater than 20000 Pa*s, more preferably not greater than 15000 Pa*s, and even more preferably not greater than 10000 Pa*s. In addition, such a viscosity is achieved at a temperature of preferably from 40 to 80° C. and more preferably from 50 to 60° C.

### Aspect of Embedding Percentage 100%

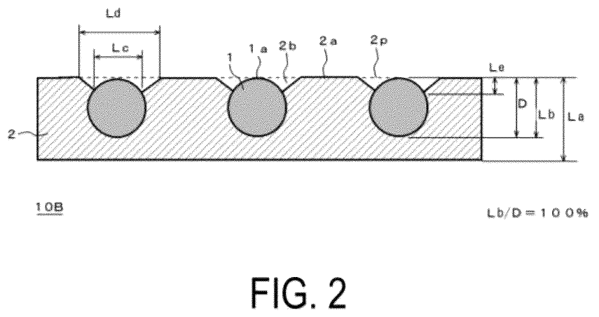

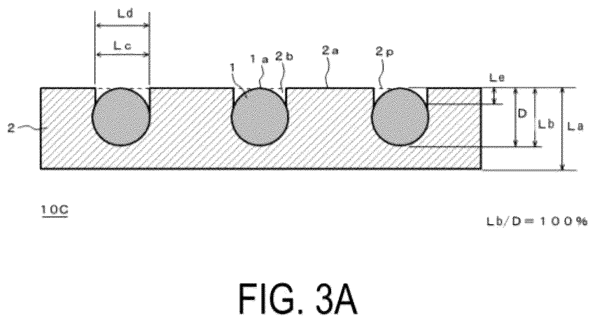

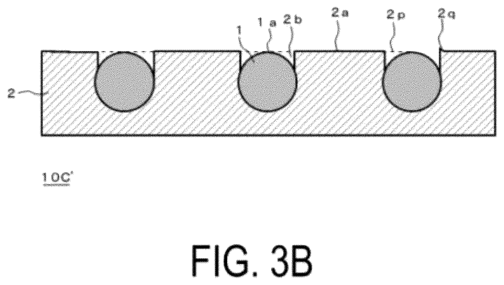

Examples of filler-containing films according to the present invention having an aspect of an embedding percentage (Lb/D) of 100% include a filler-containing film including, as illustrated for a filler-containing film 10B illustrated in FIG. 2, the inclinations 2b that form ridges approximately along the outer shape of the fillers, similarly as in the filler-containing film 10A illustrated in FIG. 1B, where ridges are formed around the fillers 1, and having an exposed diameter Lc of the fillers 1 exposed from the resin layer 2 that is smaller than the particle diameter D of the fillers. Another example is a filler-containing film such as a filler-containing film 10C illustrated in FIG. 3A, in which the inclinations 2b around the exposed portions of the fillers 1 abruptly appear in the vicinity of the fillers 1 and the exposed diameter Lc of the fillers 1 is about equal to the particle diameter D of the fillers. Another example is a filler-containing film such as a filler-containing film 10D illustrated in FIG. 4, in which shallow undulations 2c are formed on the surface of the resin layer 2 and the fillers 1 are exposed from the resin layer 2 at one point of an apical part 1a of the fillers 1.

Note that fine protrusion portions 2q may be formed adjacent to the inclinations 2b of the resin layer 2 around the exposed portion of the fillers and to the undulations 2c of the resin layer 2 directly above the fillers. One example of the protrusion portions 2q is illustrated in a filler-containing film 10C′ in FIG. 3B.

The filler-containing films 10B, 10C, 10C′, and 10D have an embedding percentage of 100% and thus, the apical part 1a of the fillers 1 and the surface 2a of the resin layer 2 flush with each other. When the apical part 1a of the fillers 1 and the surface 2a of the resin layer 2 flush with each other, compared to the case illustrated in FIG. 1B, where the fillers 1 protrude from the resin layer 2, the amount of resin in the thickness direction of the film around the individual fillers hardly becomes ununiform at the time of thermocompression bonding of the filler-containing film to an article and thus, an effect can be achieved in which the movement of the fillers due to the flow movement of the resin is reduced. Note that this effect can be obtained without the embedding percentage being strictly 100%, as long as the embedding percentages are almost equal such that the apical part of the fillers 1 embedded in the resin layer 2 is flush with the surface of the resin layer 2. In other words, in a case where the embedding percentage (Lb/D) is roughly 80 to 105%, and particularly 90 to 100%, it can be said that the apical part of the fillers 1 embedded in the resin layer 2 and the surface of the resin layer 2 flush with each other and the movement of the fillers due to the flow movement of the resin can be reduced.

Among the filler-containing films 10B, 10C, 10C′, and 10D, the amount of resin around the fillers 1 hardly becomes ununiform in the filler-containing film 10D and thus, the movement of the fillers due to the flow movement of the resin can be eliminated, and further, the fillers 1 are exposed from the resin layer 2, even at the one point of the apical part 1a, and thus, bonding between the fillers and the article is facilitated, and when the filler-containing film is an anisotropic conductive film, an effect can be expected in which the conductive particle 1 capturing performance in the terminal is good and even a slight movement of the conductive particles hardly occurs. Thus, this aspect is particularly useful in fine pitch and when the space between bumps is narrow.

Note that the filler-containing films 10B (FIG. 2), 10C (FIG. 3A), and 10D (FIG. 4) in which the shape and the depth of the inclinations 2b and the undulations 2c are different, can be manufactured by changing the viscosity and the like of the resin layer 2 during pushing of the fillers 1 into the resin layer 2, as described later.

### Aspect of Embedding Percentage More Than 100%

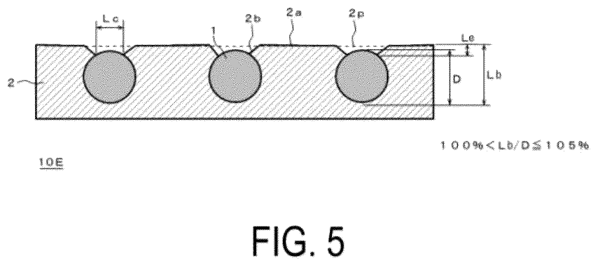

Among the filler-containing films in the present invention, examples in which the embedding percentage is more than 100% include a filler-containing film such as a filler-containing film 10E illustrated in FIG. 5 in which the fillers 1 are exposed and the inclinations 2b are formed with respect to the tangent plane 2p in the resin layer 2 around the exposed portion, and a filler-containing film such as a filler-containing film 10F illustrated in FIG. 6 in which the undulations 2c are formed with respect to the tangent plane 2p on the surface of the resin layer 2 directly above the fillers 1.

Note that the filler-containing film 10E (FIG. 5) including the inclinations 2b on the resin layer 2 around the exposed portion of the fillers 1 and the filler-containing film 10F (FIG. 6) including the undulations 2c on the resin layer 2 directly above the fillers 1 can be manufactured by changing the viscosity and the like of the resin layer 2 during pushing of the fillers 1 into the resin layer 2 at the time of manufacturing.

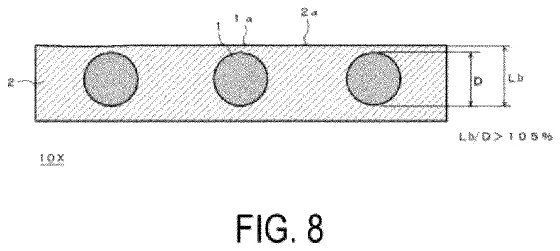

When pressure bonding is performed on the filler-containing film 10E illustrated in FIG. 5 and an article, the fillers 1 are directly pushed by the article and thus, the article and the fillers can be easily bonded, and when the filler-containing film is configured as an anisotropic conductive film, the conductive particle capturing performance in the terminal is improved. Furthermore, when pressure bonding is performed on the filler-containing film 10F illustrated in FIG. 6 and an article, the fillers 1 are pushed via the resin layer 2, without being directly pushed by the article and the amount of resin present in the pushing direction is lower compared to a state in FIG. 8 (that is, a state where the fillers 1 are embedded with an embedding percentage of more than 100%, the fillers 1 are not exposed from the resin layer 2, and the surface of the resin layer 2 is flat), and thus, pushing force is easily exerted on the fillers. Therefore, when the filler-containing film is configured as an anisotropic conductive film, an unnecessary movement of the conductive particles 1 between the terminals due to the flow movement of the resin can be prevented at the time of anisotropic conductive connection.

From the perspective of easily achieving the effect of the inclinations 2b on the resin layer 2 around the exposed portion of the fillers (FIG. 1B, FIG. 2, FIG. 3A, FIG. 3B, and FIG. 5) and the undulations 2c of the resin layer 2 directly above the fillers (FIG. 4 and FIG. 6), as described above, a ratio between the maximum depth Le of the inclinations 2b around the exposed portion of the fillers 1 and the particle diameter D of the fillers 1 (Le/D) is preferably less than 50%, more preferably less than 30%, and even more preferably from 20 to 25%, a ratio between the maximum diameter Ld of the inclinations 2b around the exposed portion of the fillers 1 and the particle diameter D of the fillers 1 (Ld/D) is preferably 100% or more and more preferably from 100% to 150%, and a ratio between the maximum depth Lf of the undulations 2c in the resin directly above the fillers 1 and the particle diameter D of the fillers 1 (Lf/D) is larger than 0, preferably less than 10%, and more preferably not more than 5%.

Note that the exposed diameter of the fillers 1 (that is, a diameter of the exposed portion) Lc can be not greater than the particle diameter D of the fillers 1 and is preferably 10 to 90% of the particle diameter D of the fillers. The fillers 1 may be exposed at one point at the apical part of the fillers 1, as illustrated in FIG. 4, or the fillers 1 may be completely embedded in the resin layer 2 so that the exposed diameter Lc is zero.

On the other hand, when the apical part of the fillers 1 embedded in the resin layer 2 and the surface of the resin layer 2 flush approximately with each other, and when an area exists where fillers having a concavity depth of the inclinations 2b or the undulations 2c (distance of the deepest part of the concavity from the tangent plane to the central portion between adjacent fillers) that is 10% or more of the particle diameter (hereinafter, simply referred to as “filler being flush with resin layer and having concavity depth of 10% or more”) are locally concentrated, there may be damage to the outer appearance of the filler-containing film, even when there is no problem concerning the performance and the quality of the filler-containing film. Furthermore, when the inclinations 2b or the undulations 2c of such an area are directed to an article to bond the filler-containing film to the article, the inclinations 2b or the undulations 2c may cause lifting of the film and the like after bonding. For example, when the filler-containing film is an anisotropic conductive film, a reduction of the conductivity may occur when conductive particles being flush with the insulating resin layer 2 and having inclinations or undulations of a concavity depth of 10% or more, exist in a concentrated manner in one bump and thus a lifting of the film occurs after connection to the bump. Therefore, in an area within 200 times the particle diameter of the fillers from any filler being flush with the resin layer 2 and having a concavity depth of 10% or more, the percentage of the fillers being flush with the resin layer and having a concavity depth of 10% or more is preferably not more than 50%, more preferably not more than 40%, and even more preferably not more than 30% with respect to the total number of fillers. In contrast, in an area where this percentage is more than 50%, the concavities of the inclinations 2b or the undulations 2c are preferably designed shallow by distributing a resin on the surface of the filler-containing film, and the like. In this case, the resin to be distributed preferably has lower viscosity than the resin forming the resin layer 2 and it is desirable that the concentration of the resin to be distributed is diluted to an extent that the concavities of the resin layer 2 can be confirmed after the distribution. By designing the concavities of the inclinations 2b or the undulations 2c shallow, the above-described problems regarding outer appearance and lifting of the film can be improved.

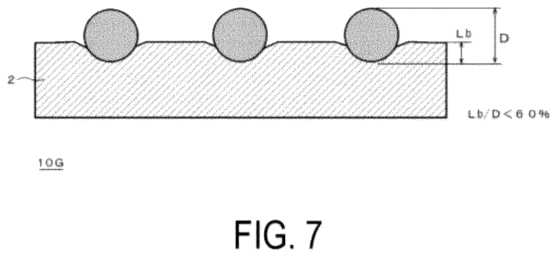

Note that, in a filler-containing film 10G having an embedding percentage (Lb/D) of less than 60%, as illustrated in FIG. 7, the fillers 1 tend to roll on the resin layer 2 and thus, in order to improve the connection state between the fillers and the article during pressure bonding of the filler-containing film to the article, especially when the filler-containing film is configured as an anisotropic conductive film, the embedding percentage (Lb/D) is preferably 60% or more from the perspective of improving the capturing percentage of the conductive particles in the terminal at the time of anisotropic conductive connection.

Furthermore, when the surface of the resin layer 2 is flat in an aspect where the embedding percentage (Lb/D) is more than 100%, as in a filler-containing film 10X according to a Comparative Example illustrated in FIG. 8, the amount of resin between the fillers 1 and the terminal is excessively large at the time of thermocompression bonding between the filler-containing film and the article, and further, the fillers 1 push the article via the resin layer, without pushing the article directly, and thus, the fillers tend to be carried away by the flow movement of the resin.

In the present invention, the presence of the inclinations 2b and the undulations 2c on the surface of the resin layer 2 can be confirmed by observing the cross section of the filler-containing film by a scanning electron microscope or can be confirmed by observation of the surface field of view. Observation of the inclinations 2b and the undulations 2c is also possible with an optical microscope or a metallurgical microscope. Furthermore, the size of the inclinations 2b and the undulations 2c can also be confirmed by adjusting the focus during image observation and the like. Even after reducing the inclinations or the undulations by heat-pressing as mentioned above, the remaining inclinations or undulations can be confirmed by a procedure similar to the one described above.

### Modified Aspect of Filler-Containing Film

### Second Resin Layer

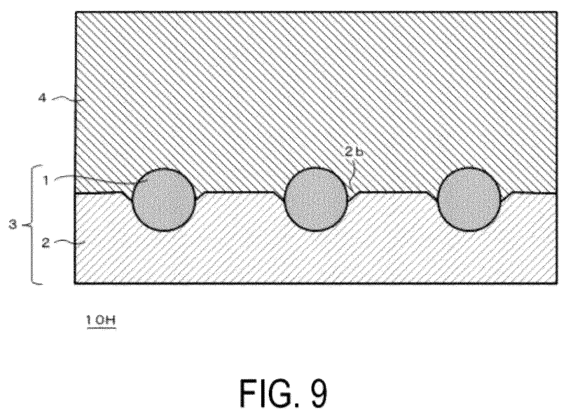

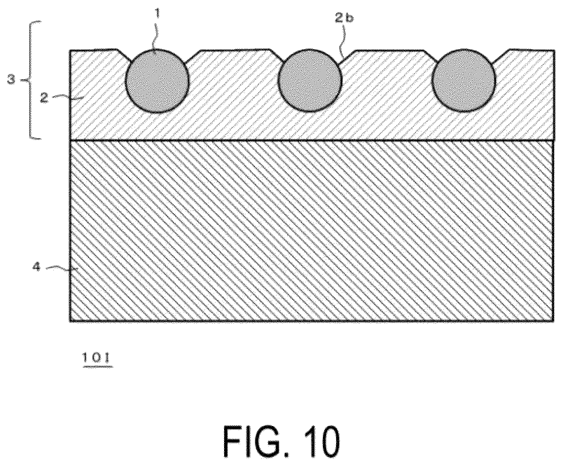

In the filler-containing film according to the present invention, such as in a filler-containing film 10H illustrated in FIG. 9, a second resin layer 4 that preferably has a lower minimum melt viscosity than the resin layer 2 may be laminated on the surface of the resin layer 2 of the filler dispersion layer 3 on which the inclinations 2b are formed. The second resin layer and a later-described third resin layer are layers in which the resin layer itself does not contain the fillers 1 dispersed in the filler dispersion layer 3. Furthermore, as in a filler-containing film 10I illustrated in FIG. 10, the second resin layer 4 that has a lower minimum melt viscosity than the resin layer 2 may be laminated on the surface of the resin layer 2 of the filler dispersion layer 3 on which the inclinations 2b are not formed. The same applies to a case where the undulations 2c are formed instead of the inclinations 2b.

The second resin layer 4 may also have insulating or conductive properties in accordance with the purpose of the filler-containing film. By laminating the second resin layer 4, the adhesiveness between articles can be improved when performing thermocompression bonding on two articles opposite to each other with the filler-containing film interposed therebetween. In particular, when the filler-containing film is configured as an anisotropic conductive film including an insulating resin layer as the second resin layer, the adhesiveness between electronic components can be improved by filling, with the second resin layer, spaces formed by electrodes or bumps of the electronic components during connecting the electronic components by an anisotropic conductive connection.

When a filler-containing film including the second resin layer 4 is used to connect articles opposite to each other, it is preferable that the second resin layer 4 is formed on an article side to which pressure is applied by a tool for thermocompression bonding, regardless of whether the second resin layer 4 is formed on the surface on which the inclinations 2b are formed. When the filler-containing film is configured as an anisotropic conductive film, it is preferable that the second resin layer 4 is formed on the first electronic component side such as an IC chip to which pressure is applied by the tool for thermocompression bonding (in other words, the resin layer 2 is formed on the second electronic component side such as a substrate mounted on a stage). As a result, an undesired movement of the fillers can be avoided, and the conductive particle capturing performance in the anisotropic conductive film can be improved at the time of anisotropic conductive connection. The same applies to a case where the undulations 2c are formed instead of the inclinations 2b. Note that, when the first electronic component and the second electronic component are connected by using an anisotropic conductive film, the first electronic component and the second electronic component are typically subjected to final pressure bonding after the anisotropic conductive film is temporarily pressure- bonded to the second electronic component while the first electronic component such as an IC chip is on the pressing jig side and the second electronic component such as a substrate is on the stage side, but depending on the size or the like of the thermocompression bonding region of the second electronic component, the first electronic component and the second electronic component may be subjected to final pressure bonding after the anisotropic conductive film is temporarily bonded to the first electronic component.

The bigger the difference between the minimum melt viscosities of the resin layer 2 and the second resin layer 4 is, the more easily a space between two articles connected via the filler-containing film can be filled with the second resin layer 4. Thus, when the first electronic component and the second electronic component are connected via an anisotropic conductive connection, the spaces formed by the electrodes or bumps of the electronic component can be easily filled with the second insulating resin layer 4 and thus, an effect of improving the adhesiveness between electronic components can be expected. Furthermore, the bigger the difference in minimum melt viscosities is, the smaller the amount of movement of the insulating resin layer 2 holding the conductive particles in a conductive particle dispersion layer is relatively with respect to the second resin layer 4 and thus, the conductive particle capturing performance in the terminal can be improved easily.

The ratio of the minimum melt viscosities of the resin layer 2 and the second resin layer 4 also depends on the ratio of the layer thicknesses of the resin layer 2 and the second resin layer 4, however, from a practical standpoint, is preferably 2 or more, more preferably 5 or more, and even more preferably 8 or more. On the other hand, when this ratio is too large, protrusion or blocking of the resin may occur when a long filler-containing film is formed into a wound body, and therefore, the ratio is preferably not greater than 15 from a practical standpoint. More specifically, the preferable minimum melt viscosity of the second resin layer 4 satisfies the ratio described above and is not greater than 3000 Pa*s, more preferably not greater than 2000 Pa*s, and particularly preferably from 100 to 2000 Pa*s.

Note that the second resin layer 4 can be formed by adjusting the viscosity of a resin composition similar to the resin layer 2.

The thickness of the second resin layer 4 can be configured appropriately in accordance with the purpose of the filler-containing film. This thickness is influenced in part by the article to be bonded by thermocompression bonding and a condition of the thermocompression bonding and thus, the thickness is not particularly limited, however, from the perspective of not excessively increasing the difficulty of a laminating process of the second resin layer 4, it is generally preferable that the thickness is from 0.2 to 50 times the particle diameter of the fillers. Furthermore, when the filler-containing film is configured as the anisotropic conductive film 10H or 10I, the layer thickness of the second resin layer 4 is preferably from 4 to 20 μm and preferably from 1 to 8 times the conductive particle diameter.

Furthermore, a total minimum melt viscosity of the filler-containing film 10H or 10I in which the resin layer 2 and the second resin layer 4 are combined is determined in accordance with the purpose of the filler-containing film, the ratio of the thicknesses of the resin layer 2 and the second resin layer 4, and the like. However, when the filler-containing film is configured as an anisotropic conductive film, the total minimum melt viscosity is not greater than 8000 Pa*s from a practical standpoint and may be from 200 to 7000 Pa*s and preferably from 200 to 4000 Pa*s to facilitate filling between bumps.

### Third Resin Layer

In the filler-containing film according to the present invention, a third resin layer may be provided on the side opposite to the second resin layer 4 with the resin layer 2 interposed between the second resin layer 4 and the third resin layer. The third resin layer may also have insulating or conductive properties in accordance with the purpose of the filler-containing film. For example, when the filler-containing film is configured as an anisotropic conductive film including an insulating third resin layer, the third resin layer may be made to function as a tack layer. When the filler-containing film is configured as an anisotropic conductive film, the third resin layer may, similarly to the second resin layer, also be provided to fill the spaces formed by the electrodes or bumps of the electronic component.

The resin composition, viscosity, and thickness of the third resin layer may be similar to or different from those of the second resin layer. The minimum melt viscosity of the filler-containing film combining the resin layer 2, the second resin layer 4, and the third resin layer is not particularly limited but may be not greater than 8000 Pa*s, from 200 to 7000 Pa*s, or from 200 to 4000 Pa*s.

### Other Laminating Aspects

According to the purpose of the filler-containing film, filler dispersion layers may be laminated, a layer not containing a filler, such as the second resin layer, may be interposed between the laminated filler dispersion layers, and the second resin layer or the third resin layer may be provided on the outmost layer.

### Production Method of Filler-Containing Film

A production method of the filler-containing film according to the present invention includes a step of forming a filler dispersion layer in which the fillers are dispersed in the resin layer. The step of forming the filler dispersion layer includes a step of holding the fillers on a surface of the resin layer in a certain area occupancy ratio and a step of pushing the fillers held on the resin layer into the resin layer.

In the step of holding the fillers on the surface of the resin layer, the CV value of the particle diameter of the fillers held on the surface of the resin layer is not greater than 20%. Furthermore, the fillers are dispersed on the surface of the resin layer and the fillers are held on the surface of the resin layer so that the area occupancy ratio of the fillers calculated by the formula below is 0.3% or more.

Area occupancy ratio (%)=[Number density of fillers in plan view]*[Average plan view area of one filler]* 100

On the other hand, in the step of pushing the fillers held on the resin layer into the resin layer, the fillers held on the surface of the resin layer are pushed into the resin layer so that the surface of the resin layer in the vicinity of the fillers includes inclinations or undulations with respect to the tangent plane to the central portion of the surface of the resin layer between adjacent fillers.

The resin layer into which the fillers are pushed is not particularly limited, as long as the above-described inclinations 2b or undulations 2c can be formed, however, the minimum melt viscosity is preferably not less than 1100 Pa*s, and the viscosity at 60° C. is preferably not less than 3000 Pa*s. Among these, the minimum melt viscosity is preferably not less than 1500 Pa*s, more preferably not less than 2000 Pa*s, even more preferably from 3000 to 15000 Pa*s, and particularly preferably from 3000 to 10000 Pa*s and the lower limit of the viscosity at 60° C. is preferably not less than 3000 Pa*s, more preferably not less than 4000 Pa*s, and even more preferably not less than 4500 Pa*s, and the upper limit of the viscosity is preferably not greater than 20000 Pa*s, more preferably not greater than 15000 Pa*s, and even more preferably not greater than 10000 Pa*s.

When the filler-containing film is formed of a single layer of the filler dispersion layer 3, the filler-containing film according to the present invention is manufactured, for example, by holding the fillers 1 in a prescribed arrangement on the surface of the resin layer 2 and pushing the fillers 1 into the resin layer by a flat plate or a roller. Note that, when manufacturing a filler-containing film having an embedding percentage of more than 100%, the pushing may be performed by a push plate including convex portions corresponding to the arrangement of the fillers.

Here, the embedded amount of the fillers 1 in the resin layer 2 can be adjusted by the pushing force, the temperature, and the like at the time of pushing the fillers 1 into the resin layer 2. Furthermore, the shape and the depth of the inclinations 2b and the undulations 2c is adjusted by the viscosity of the resin layer 2, the pushing rate, the temperature, and the like at the time of pushing.

A known technique can be utilized as a technique of holding the fillers 1 on the resin layer 2. For example, the fillers 1 can be held on the resin layer 2 by distributing the fillers 1 directly on the resin layer 2 or by attaching the fillers 1 in a single layer on a film that can be stretched by biaxial stretching, stretching this film by biaxial stretching, and pushing the resin layer 2 on the stretched film to transfer the fillers to the resin layer 2. Furthermore, the fillers 1 can also be held on the resin layer 2 by filling the fillers into a transfer mold and transferring these fillers on the resin layer 2.

When the fillers 1 are held on the resin layer 2 by using a transfer mold, the transfer mold may be, for example, a mold made from inorganic materials such as silicon, various types of ceramics, glass, and metals such as stainless steel, or organic materials such as various types of resins, and which includes an opening formed by a known opening forming process such as photolithography. Another example of the mold is a mold to which a printing method is applied. The transfer mold may have a plate shape, a roll shape, or another shape. Note that the present invention is not limited by the techniques mentioned above.

Furthermore, the second resin layer that has lower viscosity than the resin layer can be laminated on the surface of the resin layer into which the fillers have been pushed or the opposite surface.

In order to perform the pressure bonding between the filler-containing film and the article in an economic way in an industrial production line, it is preferable that the filler-containing film is manufactured to be long to a certain extent. In this case, the length of the manufactured filler-containing film is preferably not less than 5 m, more preferably not less than 10 m, and even more preferably not less than 25 m. On the other hand, when the filler-containing film is made excessively long, the use of existing devices for pressure bonding is difficult and the handleability also decreases. In this case, the length of the manufactured filler-containing film is preferably not greater than 5000 m, more preferably not greater than 1000 m, and even more preferably not greater than 500 m. Furthermore, from the perspective of excellent handleability, such a long filler-containing film is preferable formed into a wound body that is wound around a winding core.

### Usage Method of Filler-Containing Film

Similarly to former filler-containing films, the filler-containing film according to the present invention can be used to be bonded to an article and as long as the filler-containing film can be bond, the article is not particularly limited. In accordance with the purpose of the filler-containing film, the filler-containing film can be bonded to various articles by pressure bonding, or preferably by thermocompression bonding. Photoirradiation may be utilized or heat and light may be utilized in combination during this bonding. For example, when the resin layer of the filler-containing film has sufficient adhesiveness with respect to the article to which the filler-containing film is to be bond, a film-adhered body in which the filler-containing film is bonded to the surface of one article can be obtained by gentle pressing of the resin layer of the filler-containing film to the article. In this case, the surface of the article is not limited to a flat surface, but may have surface irregularities or may be curved as a whole. When the article has the shape of a film or the shape of a flat plate, the filler-containing film may be bonded to the article by using a pressure-bonding roller. As a result, the filler of the filler-containing film and the article can also be directly bonded.

Furthermore, the filler-containing film may be interposed between a first article and a second article opposite to each other and the two articles opposite to each other may be connected by a thermocompression bonding roller or a tool for pressure bonding, so that the fillers are held between these articles. Furthermore, the filler-containing film may be sandwiched between the articles so that the filler and the articles are not in direct contact.

Furthermore, when the filler-containing film is configured as an anisotropic conductive film, the anisotropic conductive film can be used for anisotropically conductively connecting a first electronic component, such as an IC chip, an IC module, or an FPC, to a second electronic component, such as an FPC, a glass substrate, a plastic substrate, a rigid substrate, or a ceramic substrate by using a tool for thermocompression bonding. The anisotropic conductive film according to the present invention may be used to laminate IC chips or wafers to produce multiple layers. Note that the electronic components that can be connected using the anisotropic conductive film according to the present invention are not limited to the electronic components mentioned above. The anisotropic conductive film according to the present invention can be used for various electronic components that are diversified in recent years.

Therefore, the present invention includes an adhered body in which the filler-containing film according to the present invention is bonded to various articles by thermocompression bonding and a production method of the adhered body. In particular, when the filler-containing film is configured as an anisotropic conductive film, the present invention also includes a production method of a connection structure, the method including a step of anisotropically conductively connecting a first electronic component and a second electronic component by using an anisotropic conductive film, and a connection structure obtained by the method, that is, a connection structure in which a first electronic component and a second electronic component are anisotropically conductively connected by an anisotropic conductive film according to the present invention.

An example of a method for connecting electronic components by using the anisotropic conductive film may be as follows. When the anisotropic conductive film is formed of a single layer of a conductive particle dispersion layer 3, the anisotropic conductive film is temporarily bonded to the second electronic component such as various types of substrates by temporary pressure bonding from a side on which the conductive particles 1 are embedded on the surface of the anisotropic conductive film, and the first electronic component such as an IC chip is fitted to a side on which the conductive particles 1 are not embedded on the surface of the anisotropic conductive film after temporary pressure bonding, to perform thermocompression bonding. In this manner, the connection can be performed. When the insulating resin layer of the anisotropic conductive film not only includes a thermal polymerization initiator and a thermo-polymerizable compound, but also includes a photopolymerization initiator and a photopolymerizable compound (which may be the same compound as the thermo-polymerizable compound), the method of pressure bonding may use light and heat in combination. In this way, an undesired movement of the conductive particles can be suppressed to a lowest limit. Furthermore, the side on which the conductive particles are not embedded may be temporarily bonded to the second electronic component to be used. Note that the anisotropic conductive film may be temporarily bonded to the first electronic component rather than the second electronic component.

Furthermore, when the anisotropic conductive film is formed of a layered body of the conductive particle dispersion layer 3 and the second insulating resin layer 4, the conductive particle dispersion layer 3 is temporarily bonded to the second electronic component such as various types of substrates, to be subjected to temporary pressure bonding, and the first electronic component such as an IC chip is aligned and mounted on the side of the second insulating resin layer 4 of the anisotropic conductive film after temporary pressure bonding, to be subjected to thermocompression bonding. The side of the second insulating resin layer 4 of the anisotropic conductive film may also be temporarily bonded to the first electronic component. Furthermore, the side of the conductive particle dispersion layer 3 may also be temporarily bonded to the first electronic component.

### EXAMPLES

Below, an anisotropic conductive film that is one aspect of the filler-containing film according to the present invention is described in detail by using Examples.

### EXAMPLES 1 to 11, COMPARATIVE EXAMPLES 1 and 2

### (1) Manufacture of Anisotropic Conductive Film

Resin compositions forming insulating resin layers and second insulating resin layers were each prepared with the compositions shown in Table 1.

The resin composition forming the insulating resin layer was applied on a PET film having a film thickness of 50 μm using a bar coater, and dried for 5 minutes in an oven at 80° C. to form the insulating resin layer having the thickness shown in Table 2 on the PET film. Similarly, the second insulating resin layer was formed on the PET film with the thickness shown in Table 2.

TABLE 1
(Part by mass)

| | | | | | | | | | | | | | Comparative | |
|---|---|---|---|---|---|---|---|---|---|---|---|---|---|---|
| | | Examples | | | | | | | | | | | Examples | |
| | | 1 | 2 | 3 | 4 | 5 | 6 | 7 | 8 | 9 | 10 | 11 | 1 | 2 |
| Insulating | Phenoxy resin (Nippon Steel & Sumikin | 40 | 40 | 40 | 40 | 25 | 40 | 40 | 40 | 35 | 40 | 35 | 40 | 40 |
| resin | Chemical Co., Ltd., YP-50) | | | | | | | | | | | | | |
| layer | Silica filler (Nippon Aerosil Co., Ltd., | 25 | 25 | 25 | 25 | 20 | 15 | 15 | 15 | 10 | 15 | 10 | 25 | 15 |
| | Aerosil R805) | | | | | | | | | | | | | |
| | Liquid epoxy resin (Mitsubishi Chemical | 30 | 30 | 30 | 30 | 15 | 40 | 40 | 40 | 15 | 40 | 15 | 30 | 40 |
| | Corp., jER828) | | | | | | | | | | | | | |
| | Silane coupling agent (Shin-Etsu Chemical | 2 | 2 | 2 | 2 | 2 | 2 | 2 | 2 | 2 | 2 | 2 | 2 | 2 |
| | Co., Ltd., KBM-403) | | | | | | | | | | | | | |
| | Thermal cationic polymerization initiator | 3 | 3 | 3 | 3 | — | 3 | 3 | 3 | — | 3 | — | 3 | 3 |
| | (Sanshin Chemical Industry Co., Ltd., | | | | | | | | | | | | | |
| | SI-60L) | | | | | | | | | | | | | |
| | Microcapsule-type latent curing agent | — | — | — | — | 38 | — | — | — | 38 | — | 38 | — | — |
| | (Asahi Kasei Corp., Novacure HX3941HP) | | | | | | | | | | | | | |
| Second | Phenoxy resin (Nippon Steel & Sumikin | 40 | 40 | 40 | 40 | 30 | — | — | — | — | — | — | 40 | — |
| insulating | Chemical Co., Ltd., YP-50) | | | | | | | | | | | | | |
| resin | Silica filler (Nippon Aerosil Co., Ltd., | 5 | 5 | 5 | 5 | 5 | — | — | — | — | — | — | 5 | — |
| layer | Aerosil R805) | | | | | | | | | | | | | |
| | Liquid epoxy resin (Mitsubishi Chemical | 50 | 50 | 50 | 50 | 25 | — | — | — | — | — | — | 50 | — |
| | Corp., jER828) | | | | | | | | | | | | | |
| | Silane coupling agent (Shin-Etsu Chemical | 2 | 2 | 2 | 2 | 2 | — | — | — | — | — | — | 2 | — |
| | Co., Ltd., KBM-403) | | | | | | | | | | | | | |
| | Thermal cationic polymerization initiator | 3 | 3 | 3 | 3 | — | — | — | — | — | — | — | 3 | — |
| | (Sanshin Chemical Industry Co., Ltd., | | | | | | | | | | | | | |
| | SI-60L) | | | | | | | | | | | | | |
| | Microcapsule-type latent curing agent | — | — | — | — | 38 | — | — | — | — | — | — | — | — |
| | (Asahi Kasei Corp., Novacure HX3941HP) | | | | | | | | | | | | | |

On the other hand, a mold was produced to ensure that the conductive particles 1 are arranged in the square lattice arrangement in plan view illustrated in FIG. 1A with a distance between particles that is equal to the particle diameter of the conductive particles and that the number density of the conductive particles is 28000 particles/mm². That is, a mold was produced in which a pattern of convex portions of the mold is the square lattice arrangement, pitches of the convex portions in the lattice axis are twice the average conductive particle diameter (3 μm), and the angle θ formed by the lattice axis and the short-side direction of the anisotropic conductive film (long-side direction of the terminal) is 15°. Known transparent resin pellets were melted and, while melted, poured into the mold, and the melted transparent resin was cooled and allowed to harden. Thus, a resin mold having concavities in the arrangement pattern illustrated in FIG. 1A was formed.

Metal-coated resin particles (Sekisui Chemical Co,. Ltd., AUL703, average particle diameter: 3 μm) were prepared as conductive particles, and these conductive particles were used to fill the concavities of the resin mold. This was covered with the insulating resin layer described above and pressed at 60° C. and at 0.5 MPa to achieve bonding. The insulating resin layer was then peeled from the mold, and the conductive particles on the insulating resin layer were pressurized (pushing conditions: 60 to 70° C., 0.5 MPa) to push the conductive particles into the insulating resin layer, thereby producing an anisotropic conductive film formed of a single layer of conductive particles (Examples 6 to 11 and Comparative Example 2). The embedded state of the conductive particles was controlled by the pushing conditions. Note that the CV value of the used metal-coated resin particles obtained by measuring a particle number of 1000 particles or more using the FPIA-3000 (from Malvern Panalytical Ltd.) was not greater than 20%.

The area occupancy ratio of the conductive particles in the anisotropic conductive film manufactured in this way is

$$28000 particles / {mm}^{2} * ( 1.5 * 1.5 * 3.14 * 1 {0}^{- 6} ) * 100 = 19.8 \%$$

A two-layer type anisotropic conductive film (Examples 1 to 5 and Comparative Example 1) was produced by laminating a second insulating resin layer on a similarly produced conductive particle dispersion layer.

### (2) Embedded State

The anisotropic conductive films of each of the Examples 1 to 11 and the Comparative Examples 1 and 2 were cut along a cutting-plane line passing through the conductive particles, and this cross section was observed with a metallurgical microscope. Furthermore, the film surface of Examples 4 to 11 and Comparative Example 2, in which the conductive particles are exposed from the surface of the anisotropic conductive film or in the vicinity of the film surface of the anisotropic conductive film, was observed with a metallurgical microscope. An upper surface image of Example 4 is illustrated in FIG. 11A and an upper surface image of Example 8 is illustrated in FIG. 11B.

In Examples 1 to 6 and 9 to 11, and in Comparative Example 1, the conductive particles were exposed from the insulating resin layer. Among these, the inclinations 2b were observed on the surface of the insulating resin layer around the conductive particles in Examples 1 to 6 and 9 to 11, and it was observed that the surface part around them (portion outside of the dashed line in FIG. 11A) was flat. On the other hand, no inclinations were observed around the conductive particles in Comparative Example 1.

In Example 8, the conductive particles were completely embedded in the insulating resin layer and the conductive particles were not exposed from the insulating resin layer, and further, the undulations 2c were observed on the surface of the insulating resin layer directly above the conductive particles and it was observed that the surface part around them (portion outside of the dashed line in FIG. 11B) was flat. The embedding percentage in Comparative Example 2 was slightly greater than 100% and the conductive particles were not exposed from the resin layer, and further, it was observed that the surface of the resin layer was flat and no undulations were observed on the surface of the resin layer directly above the conductive particles.

Note that the anisotropic conductive film in Example 7 is an example where inclinations 2b as in Example 6 and undulations 2c as in Example 8 co-exist. Inclinations 2b were observed on the surface of the insulating resin layer around the conductive particles exposed from the insulating resin layer and further, it was observed that the surface part around them was flat. On the other hand, undulations 2c were observed on the surface of the insulating resin layer directly above the conductive particles embedded completely in the insulating resin layer and it was observed that the surface part around them was flat.

### (3) Evaluation

The (a) initial conduction resistance, (b) conduction reliability, and (c) particle capturing performance of the anisotropic conductive films according to the Examples and the Comparative Examples produced in (1) were measured and evaluated as follows. Results are shown in Table 2.

### (a) Initial Conduction Resistance

The anisotropic conductive film of each of the Examples and the Comparative Examples was cut down to a surface area sufficient for connection, sandwiched between an IC for conduction property evaluation and a glass substrate, and heat pressed (180° C., 60 MPa, 5 seconds) to obtain each connected object for evaluation. The conduction resistance of the obtained connected objects for evaluation was measured by a four-terminal method. From a practical standpoint, B evaluation or above in initial conduction resistance is preferable, and A evaluation is more preferable. Even when the evaluation is C, the resistance equal to or lower than 2Ω does not give rise to a practical problem.

Here, the terminal patterns of the IC for evaluation and the glass substrate corresponded to each other, and sizes thereof were as described below. In addition, when connecting the IC for evaluation and the glass substrate, the long-side direction of the anisotropic conductive film and the short-side direction of the bumps were aligned.

IC for conduction property evaluation
Outer shape: 1.8×20.0 mm
Thickness: 0.5 mm
Bump specifications: size: 30×85 μm; distance between bumps: 50 μm; bump height: 15 μm

Glass substrate (ITO wiring)
Glass material: 1737F manufactured by Corning Inc.
Outer shape: 30×50 mm
Thickness: 0.5 mm
Electrode: ITO wiring

Initial conduction resistance evaluation criteria
A: not greater than 0.3 Ω
B: greater than 0.3 Ωand less than 1 Ω
C: not less than 1 Ω

### (b) Conduction Reliability

The conduction resistance of the connected objects for evaluation produced in (a) was measured in a manner similar to the initial conduction resistance, after the objects were placed in a thermostatic chamber at a temperature of 85° C. and a humidity of 85% RH for 500 hours. From a practical standpoint, B evaluation or above in conduction reliability is preferable, and A evaluation is more preferable. Even when the evaluation is C, the resistance equal to or lower than 6Ω does not give rise to a practical problem.

Conduction reliability evaluation criteria
A: not greater than 2.5 Ω
B: greater than 2.5 Ωand less than 5 Ω
C: not less than 5 Ω

### (c) Particle Capturing Performance

An IC for evaluation of the particle capturing performance was used and this IC for evaluation and a glass substrate (ITO wiring) having a corresponding terminal pattern were aligned at 6 μm displaced from each other and heat pressed (180° C., 60 MPa, 5 seconds). Then, the number of captured conductive particles for 100 areas (6 μm×66.6 μm) where a bump of the IC for evaluation and a terminal of the substrate overlap, was counted, a minimum capturing number was determined, and evaluation using the following criteria was performed. Practically, B evaluation or above in particle capturing performance is preferable.

IC for particle capturing performance evaluation
Outer shape: 1.6×29.8 mm
Thickness: 0.3 mm
Bump specifications: size: 12×66.6 μm; bump pitch: 22 μm (L/S=12 μm/10 μm); bump height: 12 μm

Particle capturing performance evaluation criteria
A: not less than 5 particles
B: from 3 to less than 5 particles
C: less than 3 particles

TABLE 2

| | | Example | Example | Example | Example | Example | Example | Example | Example | Example | Example | Example | Comparative | Comparative |
|---|---|---|---|---|---|---|---|---|---|---|---|---|---|---|
| | | 1 | 2 | 3 | 4 | 5 | 6 | 7 | 8 | 9 | 10 | 11 | Example 1 | Example 2 |
| Particle position | | [symbol] | [symbol] | [symbol] | [symbol] | [symbol] | [symbol] | [symbol] | [symbol] | [symbol] | [symbol] | [symbol] | [symbol] | [symbol] |
| Presence of | | Inclinations | Inclinations | Inclinations | Inclinations | Inclinations | Inclinations | Inclinations | Undulations | Inclinations | Inclinations | Inclinations | No | No |
| inclinations 2b | | 2b | 2b | 2b | 2b | 2b | 2b | 2b | 2c | 2b | 2b | 2b | inclinations | undulations |
| and undulations 2c | | | | | | | | Undulations | | | | | 2b | 2c |
| | | | | | | | | 2c | | | | | | |
| Conductive particle | | 3 | 3 | 3 | 3 | 3 | 3 | 3 | 3 | 3 | 3 | 3 | 3 | 3 |
| diameter: D ( [symbol] m) | | | | | | | | | | | | | | |
| Embedding percentage: | | 63 | 87 | 100 | 100 | 103 | 103 | 103-105 | 105 | 103 | 103 | 103 | 64 | >100 |
| (100 [symbol] Lb/D) (%) | | | | | | | | | | | | | | |
| [symbol] particle | | 3 | 3 | 3 | 2.2 | 2.3 | 2.4 | 0-2.4 | 0 | 2.4 | 2.4 | 2.4 | [symbol] | 0 |
| diameter: [symbol] c (μm) | | | | | | | | | | | | | | |
| Embedded amount: | | 1.9 | 2.6 | 3 | 3.0 | 3.1 | 3.1 | 3.1-3.2 | 3.2 | 3.1 | 3.1 | 3.1 | 1.9 | >3.0 |
| [symbol] b ( [symbol] ) | | | | | | | | | | | | | | |
| Minimum film | | 2.1 | 1.4 | 1.0 | 1.0 | 0.9 | 14.9 | 14.8 | 14.8 | 14.9 | 14.9 | 14.9 | 1.8 | 14.8 |
| thickness at | | | | | | | | | | | | | | |
| position of conductive | | | | | | | | | | | | | | |
| particle: Lg ( [symbol] ) | | | | | | | | | | | | | | |
| Thickness | Insulating | 4 | 4 | 4 | 4 | 4 | 18 | 18 | 18 | 18 | 30 | 30 | 4 | 18 |
| (μm) | resin | | | | | | | | | | | | | |
| | layer | | | | | | | | | | | | | |
| | (La) | | | | | | | | | | | | | |
| | Second | 14 | 14 | 14 | 14 | 14 | [symbol] | [symbol] | [symbol] | [symbol] | [symbol] | [symbol] | 14 | [symbol] |
| | insulating | | | | | | | | | | | | | |
| | resin | | | | | | | | | | | | | |
| | layer | | | | | | | | | | | | | |
| | La/D | 1.3 | 1.3 | 1.3 | 1.3 | 1.3 | 6 | 6 | 6 | 6 | 10 | 10 | 1.3 | 6 |
| Minimum | Tack | [symbol] | [symbol] | [symbol] | [symbol] | [symbol] | [symbol] | [symbol] | [symbol] | [symbol] | [symbol] | [symbol] | [symbol] | [symbol] |
| melt | layer | | | | | | | | | | | | | |
| viscosity | Insulating | 6000 | 6000 | 6000 | 6000 | 6000 | 3000 | 3000 | 3000 | 3000 | 3000 | 3000 | 1000 | 1000 |
| (Pa · s) | resin | | | | | | | | | | | | | |
| | layer | | | | | | | | | | | | | |
| | Second | 800 | 800 | 800 | 800 | 800 | [symbol] | [symbol] | [symbol] | [symbol] | [symbol] | [symbol] | 800 | [symbol] |
| | insulating | | | | | | | | | | | | | |
| | resin | | | | | | | | | | | | | |
| | layer | | | | | | | | | | | | | |
| | Insulating | 8 | 8 | 8 | 8 | 8 | [symbol] | [symbol] | [symbol] | [symbol] | [symbol] | [symbol] | 1 | [symbol] |
| | resin | | | | | | | | | | | | | |
| | layer/ [symbol] | | | | | | | | | | | | | |

[symbol]

indicates data missing or illegible when filed

From Table 2, the followings can be understood. The initial conduction resistance and the conduction reliability of Examples 1 to 7 and 9, in which it can be understood that the embedding percentage of the conductive particles is from 60 to 105% and the conductive particles are exposed from the insulating resin layer and which include the inclinations 2b, and Example 8 in which the conductive particles are completely embedded in the insulating resin layer and which includes the undulations 2c, both have A evaluation and the particle capturing performance of these Examples is also excellent. However, the particle capturing performance of Comparative Example 1 in which the embedding percentage is in this range and the conductive particles are exposed from the insulating resin layer and which does not include the inclinations 2b, and Comparative Example 2 in which the embedding percentage is about 100% and the conductive particles are completely embedded in the insulating resin layer, and which does not include the undulations 2c, have C evaluation, and it was understood that the conductive particles are not held during the connection and thus, they can not be used in a fine pitch connection. Thus, when the surface of the insulating resin layer 2 is flat around or directly above the conductive particles 1, it can be presumed that the conductive particles tend to receive an influence from the flow movement of the resin at the time of anisotropic conductive connection and that the pushing of the conductive particles to the terminal is insufficient.

Furthermore, it can be understood that, in the above-described Examples 1 to 7 and 9, the minimum melt viscosity of the insulating resin layer is 2000 Pa*s or more and the melt viscosity at 60° C. is 3000 Pa*s or more, whereas in the Comparative Examples 1 and 2, the minimum melt viscosity is 1000 Pa*s and the melt viscosity at 60° C. is 1500 Pa*s, and the inclinations 2b and the undulations 2c could not be formed due to the viscosity at the time of pushing being too low as a result of the adjustment of the pushing conditions of the conductive particles.

From Examples 4 and 5 and Examples 6 and 9, it was understood that the evaluation of the particle capturing performance is excellent from a practical standpoint, both when the anisotropic conductive film is configured as a two-layer type film including the conductive particle dispersion layer and the second insulating resin layer and when the anisotropic conductive film is configured as a single-layer film of the conductive particle dispersion layer.

From Example 3 and Examples 4 and 5, it was understood that, in the anisotropic conductive film configured as a two-layer type film including the conductive particle dispersion layer and the second insulating resin layer, the evaluation of the particle capturing performance is excellent from a practical standpoint, both when the second insulating resin layer is laminated on the surface of the insulating resin layer into which the conductive particles were pushed, and when the second insulating resin layer is laminated on the opposite side of the surface of the insulating resin layer into which the conductive particles were pushed.

Note that nearly the same results were obtained in a similar evaluation of a surface obtained from spraying a diluted resin composition same as the above on the surface from which the conductive particles of the anisotropic conductive film according to Examples 4 and 5 are exposed and forming this surface nearly flat.

In the objects for evaluation of all Examples for which the initial conduction was measured, the number of short circuits between bumps was counted in 100 places by a similar measurement method of the number of short circuits as described in an Example in JP 2016-085983 A, and no short circuit was observed. Furthermore, in a determination of the short occurrence rate following a measurement method of the short occurrence rate according to an Example described in JP 2016-085982 A, it was confirmed that all short occurrence rates in the anisotropic conductive films according to all Examples were below 50 ppm and that practical use is possible without problems. Note that in the case of an anisotropic conductive film in which the conductive particles are mixed and randomly dispersed within the insulating resin, the short occurrence rate is higher than the above-described rate in the number of digits. This can be confirmed by referring to Comparative Example 2 of Patent Document 2, Comparative Example 2 of Patent Document 3, and the like.

Note that, for the anisotropic conductive film according to Example 7 in which the inclinations and the undulations co-exist, the similar results to Examples 6 and 8 were obtained. Thus, it can be understood that the effect is produced by the presence of the inclinations or the undulations in the vicinity of the conductive particles. Furthermore, the same effect was obtained in Examples 6 to 8, and this indicates that the manufacturing conditions of the anisotropic conductive film can take a wide margin. As a result, various effects such as a reduction of manufacturing costs of the anisotropic conductive film and a speeding up of a design change can be expected, and therefore, the merits in industrial use are great.

### EXAMPLES 1 TO 4

### Production of Anisotropic Conductive Film

Resin compositions forming insulating resin layers and second insulating resin layers were prepared with the compositions shown in Table 3 to investigate the effects of the resin composition of the insulating resin layer on the film forming capacity and the conduction properties of anisotropic conductive films to be used in COG connection. In this case, the minimum melt viscosity of the resin composition was adjusted by the preparation conditions of the insulating resin composition. The obtained resin compositions were used to form insulating resin layers in a manner similar to Example 1 and by pushing conductive particles into these insulating resin layers, anisotropic conductive films formed of single layers of the conductive particle dispersion layers were produced and second insulating resin layers were further laminated on the side of the insulating resin layers onto which the conductive particles were pushed to produce the anisotropic conductive films shown in Table 4. In this case, the disposition of the conductive particles is the same as in Example 1.

Furthermore, the conductive particles reached the embedded states shown in Table 4, by appropriately adjusting the pushing conditions of the conductive particles.

In the production process of this anisotropic conductive film, the film shape was not maintained in Experimental Example 4 after the conductive particles were pushed into the insulating resin layer (film shape evaluation: NG), but the film shape was maintained in the other experimental examples (film shape evaluation: OK). Therefore, the embedded state of the conductive particles was observed and measured with a metallurgical microscope for the anisotropic conductive films of the experimental examples excluding Experimental Example 4, and the following evaluation was further performed.

Note that, although the inclinations or both the inclinations and the undulations were observed in each of the experimental examples excluding Experimental Example 4, the measured values for the cases in which the inclinations were most clearly observed for each experimental example are shown in Table 4. The observed embedded states satisfied the preferable range mentioned above.

TABLE 3
(Part by mass)

| | | Composition | | | |
|---|---|---|---|---|---|
| | | A | B | C | D |
| Insulating resin | Phenoxy resin (YP-50, Nippon Steel & Sumikin | 50 | 45 | 40 | 37 |
| layer | Chemical Co., Ltd.) | | | | |
| | Silica filler (Aerosil R805, Nippon Aerosil Co., Ltd.) | 20 | 10 | 10 | 8 |
| | Liquid epoxy resin (jER828, Mitsubishi Chemical Corp.) | 25 | 40 | 45 | 50 |
| | Silane coupling agent (KBM-403, | 2 | 2 | 2 | 2 |
| | Shin-Etsu Chemical Co., Ltd.) | | | | |
| | Thermal cationic polymerization initiator | 3 | 3 | 3 | 3 |
| | (SI-60L, Sanshin Chemical Industry Co., Ltd.) | | | | |

| | | |
|---|---|---|
| Second insulating | Phenoxy resin (YP-50, Nippon Steel & Sumikin | 40 |
| resin layer | Chemical Co., Ltd.) | |
| | Silica filler (Aerosil R805, Nippon Aerosil Co., Ltd.) | 5 |
| | Liquid epoxy resin (jER828, Mitsubishi Chemical Corp.) | 50 |
| | Silane coupling agent (KBM-403, | 2 |
| | Shin-Etsu Chemical Co., Ltd.) | |
| | Thermal cationic polymerization initiator | 3 |
| | (SI-60L, Sanshin Chemical Industry Co., Ltd.) | |

TABLE 4

| | | Experimental | Experimental | Experimental | Experimental |
|---|---|---|---|---|---|
| | | Example 1 | Example 2 | Example 3 | Example 4 |
| Composition of resin composition | | A | B | C | D |
| (Table 3) | | | | | |
| Film shape after pushing of conductive | | OK | OK | OK | NG |
| particles | | | | | |
| Conductive particle diameter: D (μm) | | 3 | 3 | 3 | 3 |
| Disposition of conductive particles | | Square | Square | Square | Square |
| | | lattice | lattice | lattice | lattice |
| Center distance of closest conductive | | 6 | 6 | 6 | 6 |
| particles (μm) | | | | | |
| Thickness | Insulating resin layer | 4 | 4 | 4 | 4 |
| (μm) | (La) | | | | |
| | Second insulating resin | 14 | 14 | 14 | 14 |
| | layer | | | | |
| | La/D | 1.3 | 1.3 | 1.3 | 1.3 |
| Minimum melt | Insulating resin layer | 8000 | 2000 | 1500 | 800 |
| viscosity (Pa*s) | Second insulating resin | 800 | 800 | 800 | 800 |
| | layer | | | | |
| | Total melt viscosity | 1200 | 900 | 900 | 800 |
| Viscosity at | Insulating resin layer | 12000 | 3000 | 2000 | 1100 |
| 60° C. (Pa*s) | | | | | |

Embedded state of conductive particles

| | | | | |
|---|---|---|---|---|
| Embedding percentage (100 × Lb/D)% | >80 | >95 | >95 | — |
| Exposed diameter Lc (μm) | <2.8 | <2.5 | <2.5 | — |
| Presence of inclinations or undulations | Present | Present | Present | — |
| Maximum depth Le of inclinations | <50% | <50% | <50% | — |
| (Ratio with respect to conductive | | | | |
| particle diameter D) | | | | |
| Maximum diameter Ld of inclinations | <1.3 | <1.3 | <1.3 | — |
| (Ratio with respect to conductive | | | | |
| particle diameter D) | | | | |

Evaluation

| | | | | |
|---|---|---|---|---|
| Initial conduction resistance | A | A | A | — |
| Conduction reliability | A | A | A | — |

### Evaluation

### (a) Initial Conduction Resistance and Conduction Reliability

Similarly to the Example 1, the initial conduction resistance and the conduction reliability were each evaluated in three stages. The evaluation criteria in this case were similar to Example 1. Results are shown in Table 4.

### (b) Particle Capturing Performance

The particle capturing performance was evaluated in a manner similar to Example 1.

As a result, each of the Experimental Examples 1 to 3 had B evaluation or higher.

### (c) Short Occurrence Rate

The short occurrence rate was evaluated in the same manner as in Example 1.

As a result, it was confirmed that the short occurrence rate in each of Experimental Example 1 to 3 was below 50 ppm and that practical use is possible without problems.

It can be seen from Table 4 that, when the minimum melt viscosity of the insulating resin layer is below about 1000 Pa*s, it is difficult to form a film in which the insulating resin layer has inclinations in the vicinity of the conductive particles. On the other hand, it can be seen that, when the minimum melt viscosity of the insulating resin layer was 1500 Pa*s or greater, inclinations can be formed on the surface of the insulating resin layer in the vicinity of the conductive particles by adjusting the conditions at the time of the embedding of the conductive particles, and that the resulting anisotropic conductive films have good conduction properties for COG.

### EXPERIMENTAL EXAMPLES 5 TO 8

### Production of Anisotropic Conductive Film

Resin compositions forming insulating resin layers and second insulating resin layers were prepared with the compositions shown in Table 5 to investigate the effects of the resin composition of the insulating resin layer on the film forming capacity and the conduction properties of anisotropic conductive films to be used in FOG connection. In this case, the disposition of the conductive particles was a hexagonal lattice arrangement having a number density of 15000 particles/mm², and one lattice axis thereof was inclined by 15° with respect to the long-side direction of the anisotropic conductive film. Furthermore, the minimum melt viscosity of the resin composition was adjusted by the preparation conditions of the insulating resin composition. The obtained resin compositions were used to form insulating resin layers in a manner similar to Example 1 and by pushing conductive particles into these insulating resin layers, anisotropic conductive films formed of single layers of the conductive particle dispersion layers were produced and second insulating resin layers were further laminated on the side of the insulating resin layers onto which the conductive particles were pushed to produce the anisotropic conductive films shown in Table 6. In this case, the conductive particles reached the embedded states shown in Table 6, by appropriately adjusting the pushing conditions of the conductive particles.

In the production process of this anisotropic conductive film, the film shape was not maintained in Experimental Example 8 after the conductive particles were pushed into the insulating resin layer (film shape evaluation: NG), but the film shape was maintained in the other experimental examples (film shape evaluation: OK). Therefore, the embedded state of the conductive particles was observed and measured with a metallurgical microscope for the anisotropic conductive films of the experimental examples excluding Experimental Example 8, and the following evaluation was further performed.

Note that, although the inclinations or both the inclinations and the undulations were observed in each of the experimental examples excluding Experimental Example 8, the measured values for the cases in which the inclinations were most clearly observed for each experimental example are shown in Table 6. The observed embedded states satisfied the preferable range mentioned above.

TABLE 5
(Part by mass)

| | | Composition | | | |
|---|---|---|---|---|---|
| | | E | F | G | H |
| Insulating resin | Phenoxy resin (YP-50, Nippon Steel & | 55 | 45 | 25 | 5 |
| layer | Sumikin Chemical Co., Ltd.) | | | | |
| | Phenoxy resin (FX-316ATM55, Nippon | — | — | 20 | 40 |
| | Steel & Sumikin Chemical Co., Ltd.) | | | | |
| | Bifunctional acrylate (A-DCP, | 20 | 20 | 20 | 20 |
| | Shin-Nakamura Chemical Co., Ltd.) | | | | |
| | Bifunctional urethane acrylate oligomer (UN-9200A, | 25 | 35 | 35 | 35 |
| | Negami Chemical Industrial Co., Ltd.) | | | | |
| | Silane coupling agent (A-187, Momentive | 1 | 1 | 1 | 1 |
| | Performance Materials Inc.) | | | | |
| | Phosphoric acid methacrylate (KAYAMER PM-2, | 1 | 1 | 1 | 1 |
| | Nippon Kayaku Co., Ltd.) | | | | |
| | Benzoyl peroxide (Nyper BW, NOF Corporation) | 5 | 5 | 5 | 5 |

| | | |
|---|---|---|
| Second insulating | Phenoxy resin (FX-316ATM55, Nippon | 50 |
| resin layer | Steel & Sumikin Chemical Co., Ltd.) | |
| | Bifunctional acrylate (A-DCP, | 20 |
| | Shin-Nakamura Chemical Co., Ltd.) | |
| | Bifunctional urethane acrylate oligomer | 30 |
| | (UN-9200A, Negami Chemical Industrial Co., Ltd.) | |
| | Silane coupling agent (A-187, | 1 |
| | Momentive Performance Materials Inc.) | |
| | Phosphoric acid methacrylate (KAYAMER PM-2, | 1 |
| | Nippon Kayaku Co., Ltd.) | |
| | Benzoyl peroxide (Nyper BW, NOF Corporation) | 5 |

TABLE 6

| | | Experimental | Experimental | Experimental | Experimental |
|---|---|---|---|---|---|
| | | Example 5 | Example 6 | Example 7 | Example 8 |
| Composition of resin | | E | F | G | H |
| composition (Table 5) | | | | | |
| Film shape after pushing | | OK | OK | OK | NG |
| of conductive particles | | | | | |
| Conductive particle diameter: D (μm) | | 3 | 3 | 3 | 3 |
| Disposition of conductive particles | | Hexagonal | Hexagonal | Hexagonal | Hexagonal |
| | | lattice | lattice | lattice | lattice |
| Center distance of closest | | 9 | 9 | 9 | 9 |
| conductive particles (μm) | | | | | |
| Thickness | Insulating resin | 4 | 4 | 4 | 4 |
| (μm) | layer (La) | | | | |
| | Second insulating | 14 | 14 | 14 | 14 |
| | resin layer | | | | |
| | La/D | 1.3 | 1.3 | 1.3 | 1.3 |
| Minimum melt | Insulating resin layer | 8000 | 2000 | 1500 | 800 |
| viscosity (Pa*s) | Second insulating | 800 | 800 | 800 | 800 |
| | resin layer | | | | |
| | Total melt viscosity | 1200 | 900 | 900 | 800 |
| Viscosity at | Insulating resin layer | 12000 | 3000 | 2000 | 1100 |
| 60° C. (Pa*s) | | | | | |

Embedded state of conductive particles

| | | | | |
|---|---|---|---|---|
| Embedding percentage (100 × Lb/D)% | >80 | >95 | >95 | — |
| Exposed diameter Lc (μm) | <2.8 | <2.5 | <2.5 | — |
| Presence of inclinations or undulations | Present | Present | Present | — |
| Maximum depth Le of inclinations | <50% | <50% | <50% | — |
| (Ratio with respect to conductive | | | | |
| particle diameter D) | | | | |
| Maximum diameter Ld of inclinations | <1.3 | <1.3 | <1.3 | — |
| (Ratio with respect to conductive | | | | |
| particle diameter D) | | | | |

Evaluation

| | | | | |
|---|---|---|---|---|
| Initial conduction resistance | OK | OK | OK | — |
| Conduction reliability | OK | OK | OK | — |

### Evaluation

### (a) Initial Conduction Resistance and Conduction Reliability

The (i) initial conduction resistance and (ii) conduction reliability were evaluated as follows. Results are shown in Table 6.

### (i) Initial Conduction Resistance

The anisotropic conductive film obtained in each experimental example was cut down to a surface area sufficient for connection, sandwiched between an FPC for conduction property evaluation and a non-alkali glass substrate, and pressed by a tool for thermocompression bonding having a tool width of 1.5 mm while heating (180° C., 4.5 MPa, 5 seconds) to obtain each connected object for evaluation. The conduction resistance of the obtained connected object for evaluation was measured by the four-terminal method, and the measured value was evaluated under the following criteria.

FPC for conduction property evaluation:
Terminal pitch: 20 μm
Terminal width/space between terminals: 8.5 μm/11.5 μm
Polyimide film thickness (PI)/copper foil thickness (Cu)= 38/8, Sn plating

Non-alkali glass substrate
Electrode: ITO wiring
Thickness: 0.7 mm

Initial conduction resistance evaluation criteria
OK: less than 2.0 Ω
NG: equal to or more than 2.0 Ω

### (ii) Conduction Reliability

The connected object for evaluation produced in (i) was placed in a thermostatic chamber for 500 hours at a temperature of 85° C. and a humidity of 85% RH, and then the conduction resistance was measured in the same manner as in the case of the initial conduction resistance. The measured value was evaluated under the following criteria.

Conduction reliability evaluation criteria
OK: less than 5.0 Ω
NG: equal to or more than 5.0 Ω

### (b) Particle Capturing Performance

The capturing number of conductive particles of 100 terminals of the connected object for evaluation produced in (i) was measured to determine the minimum capturing number. The minimum capturing number of 10 particles or more means that practical use is possible without problems.

The minimum capturing number in each of the Experimental Examples 5 to 7 was 10 particles or higher.

### (c) Short Occurrence Rate

The number of short circuits of the connected object for evaluation produced in (i) was counted, and the short occurrence rate was determined from the counted number of short circuits and the number of gaps of the connected object for evaluation. It was confirmed that the short occurrence rate in each of Experimental Examples 5 to 7 was below 50 ppm and that practical use is possible without problems.

It can be seen from Table 6 that, when the minimum melt viscosity of the insulating resin layer is below about 1000 Pa*s, it is difficult to form a film including inclinations on the surface of the insulating resin layer in the vicinity of the conductive particles. On the other hand, it can be seen that, when the minimum melt viscosity of the insulating resin layer was 1500 Pa*s or greater, inclinations can be formed on the surface of the insulating resin layer in the vicinity of the conductive particles by adjusting the conditions at the time of the embedding of the conductive particles, and that the resulting anisotropic conductive films have good conduction properties for FOG.

### REFERENCE SIGNS LIST

1 Filler, Conductive particles
1a Apical part of filler
2 Resin layer, Insulating resin layer
2a Surface of resin layer
2b Inclinations
2c Undulations
2f Flat surface part
2p Tangent plane
2q Protrusion portions
3 Filler dispersion layer, Conductive particle dispersion layer
4 Second resin layer, Second insulating resin layer
10A, 10B, 10C, 10C′, 10D, 10E, 10F, 10G, 10H, 10I Filler-containing film, Anisotropic conductive film according to Example
20 Terminal
A Lattice axis
D Conductive particle diameter, Particle diameter of fillers
La Layer thickness of resin layer
Lb Embedded amount (distance from tangent plane to central portion between adjacent fillers to deepest part of fillers)
Lc Exposed diameter
Ld Maximum diameter of inclinations
Le Maximum depth of inclinations
Lf Maximum depth of undulations
θ Angle formed by long-side direction of terminal and lattice axis of arrangement of conductive particles

1.-11. (canceled)

12. A method of producing a filler-containing film comprising forming a filler dispersion layer in which fillers are dispersed in a resin layer, wherein the forming comprises:
a step of dispersing fillers on a surface of the resin layer, wherein a CV value of the particle diameter of the fillers is not greater than 20%,
a step of holding the fillers on the surface of the resin layer, and
a step of pushing the fillers held on the surface of the resin layer into the resin layer, wherein:
the step of pushing the fillers into the resin layer further includes adjusting a viscosity of the resin layer, a pushing rate, or a temperature during pushing of the fillers so that the surface of the resin layer in the vicinity of the fillers comprises inclinations or undulations with respect to a tangent plane to a central portion of the surface of the resin layer between adjacent fillers,
if the inclinations are present, resin is absent from a region between the inclinations and the tangent plane, and
if the undulations are present, an amount of resin of the resin layer directly above the fillers is smaller as compared to a case where the surface of the resin layer directly above the fillers lies in the tangent plane.

13. The production method of the filler-containing film according to claim 12, wherein the step of pushing the fillers into the resin layer further comprises adjusting a pushing force, a viscosity of the resin layer, a pushing rate, or a temperature during pushing of the fillers so that Lb/D is an embedding percentage of one of the fillers in the resin layer, with Lb being a distance from the tangent plane to a deepest part of the filler in the resin layer and D being a particle diameter of the filler, wherein 80% or more of the total number of fillers included in the filler-containing film have a same numeric value of the embedding percentage, and wherein the embedding percentage numeric value is in a range from 60% to 105%.

14. The production method of the filler-containing film according to claim 12, wherein the resin layer further contains insulating filler particles, different from the fillers, having a particle diameter smaller than the particle diameter D of the filler.

15. The production method of the filler-containing film according to claim 12, wherein in the step of holding the fillers on the surface of the resin layer, an area occupancy ratio of the fillers on the surface of the resin layer is 0.3% or greater as calculated by a formula below:
$$Area occupancy ratio ( \% ) = [ Number density of fillers in plan view ] \times [ \text{} Average plan view area of one filler ] \times 100.$$

16. The production method of the filler-containing film according to claim 12, wherein the step of holding the fillers on the surface of the resin layer further includes holding the fillers in a prescribed arrangement on the surface of the resin layer, and the step of pushing the fillers into the resin layer further includes pushing the fillers into the resin layer by a flat plate or a roller.

17. The production method of the filler-containing film according to claim 12, wherein the step of holding the fillers on the surface of the resin layer further includes filling the fillers into a transfer mold and transferring these fillers to the resin layer to hold the fillers on the surface of the resin layer.

18. The production method of the filler-containing film according to claim 12, wherein the fillers are conductive particles and the resin layer of the filler dispersion layer is an insulating resin layer.

19. The method of producing the filler-containing film according to claim 12, wherein the fillers are disposed without coming into contact with each other.

20. The production method of the filler-containing film according to claim 12, wherein in the step of holding the fillers on the surface of the resin layer, the fillers are regularly arranged in the resin layer.

21. The production method of the filler-containing film according to claim 12, wherein the resin layer of the filler dispersion layer has a minimum melt viscosity of 15000 Pa*s or less.

22. The production method of the filler-containing film according to claim 12, wherein a second resin layer is formed on one surface of the resin layer of the filler dispersion layer on which the inclinations or the undulations are formed or are to be formed, or the other surface opposite to the one surface.

23. The production method of the filler-containing film according to claim 22, wherein a minimum melt viscosity of the second resin layer is lower than a minimum viscosity of the resin layer of the filler dispersion layer.

24. The production method of the filler-containing film according to claim 22, wherein a minimum melt viscosity of the filler containing film in which the resin layer and the second resin layer are combined is 8000 Pa*s or less.

25. The production method of the filler-containing film according to claim 22, wherein a third resin layer is formed on the other surface opposite to the one surface of the resin layer of the filler dispersion layer on which the second resin layer is formed.

26. The production method of the filler-containing film according to claim 25, wherein a minimum melt viscosity of the filler containing film in which the resin layer, the second resin layer and the third resin layer are combined is 8000 Pa*s or less.

27. A film adhered body, comprising an article adhered to the filler-containing film produced according to the production method of claim 12.

28. A connection structure, comprising a first article and a second article that are connected via the filler-containing film produced according to the production method of claim 12.

29. The connection structure according to claim 28, wherein the first article is a first electric component, a second article is a second electric component, the first electric component and the second component are conductively connected via the filler-containing film, the filler-containing film is a conductive film having conductive particles as the fillers, and the resin layer of the filler dispersion layer is an insulating resin layer.

30. A method of producing a connection structure, comprising pressure-bonding a first article and a second article via the filler-containing film produced according to the production method of claim 12.

31. The production method of the connection structure according to claim 30, wherein the first article is a first electric component, a second article is a second electric component, the pressure bonding includes thermocompression bonding the first electric component and the second electric component via the filler-containing film to produce a connection structure in which the first electric component and the second electric component are conductively connected, and the filler-containing film is a conductive film having conductive particles as the fillers, and the resin layer of the filler dispersion layer is an insulating resin layer.
